(19) United States
(12) Patent Application Publication
(10) Pub. No.: US 2015/0209786 A1
(43) Pub. Date: Jul. 30, 2015

(54) COMPOSITIONS AND METHODS FOR DISPENSING REAGENTS

(71) Applicant: ILLUMINA, INC., San Diego, CA (US)

(72) Inventors: Matthew Hage, San Diego, CA (US); Kenneth M. Kuhn, San Diego, CA (US); Brad Drews, San Diego, CA (US); Keith Wyshak, San Diego, CA (US); Tim Blauwkamp, Hayward, CA (US)

(21) Appl. No.: 14/608,081

(22) Filed: Jan. 28, 2015

Related U.S. Application Data
(60) Provisional application No. 61/973,769, filed on Apr. 1, 2014.
(60) Provisional application No. 61/933,430, filed on Jan. 30, 2014.

(51) Int. Cl. B01L 3/00

(52) U.S. Cl. CPC B01L 3/527; B01L 2300/0829; B01L 2400/0403; B01L 2400/0433; B01L 2200/16; B01L 2200/0642; B01L 2300/041

(57) ABSTRACT

Some embodiments of the methods and compositions provided herein include inversion plates and delivery plates. Such inversion plates and delivery plates are useful for the transfer of fluid reagents to multiwell plates.

### RELATED APPLICATIONS

This application claims the benefit of U.S. Provisional Application No. 61/933430 filed on Jan. 30, 3014, and U.S. Provisional Application No. 61/973769 filed on Apr. 1, 2014, the contents of which are incorporated herein in their entireties.

### FIELD OF THE DISCLOSURE

Some embodiments of the methods and compositions provided herein include plates for delivering fluid reagents. In some embodiments, such plates include inversion plates and delivery plates useful for the transfer of fluid reagents to multiwell plates.

### BACKGROUND

Multiwell plates are standard components in genomic research. Multiwell plates have greatly improved the sample handling capabilities of high throughput genomic research labs. However, their increased popularity and usage in the laboratory has often proved difficult for the hands of a technician. Manually preparing and transferring reagents to many tens or hundreds of wells of a multiwell plate can often invite error. In response, there has been an effort in recent years to construct automated machines to more effectively and efficiently handle multiwell plates. Prior methods and devices for transferring reagents from a source multiwell plate to a destination multiwell plate are cumbersome and expensive. Accordingly, there is a need for improved methods and devices for transferring solution from a source multiwell plate to a destination multiwell plate.

### SUMMARY OF THE INVENTION

Some embodiments of the methods and compositions provided herein include plates for delivering fluid reagents. In some embodiments, such plates include inversion plates and delivery plates useful for the transfer of fluid reagents to multiwell plates.

Some embodiments of the methods and compositions provided herein include an inversion plate for providing fluid reagent to a multiwell plate, the inversion plate comprising: a planar surface having a plurality of sites distributed thereon, wherein each site comprises a well having a rim raised above the planar surface, wherein each well is configured such that a fluid is retained in the well when the planar surface is inverted; and an alignment element configured to align with an alignment element of an alignment collar or an alignment element on a multiwell plate.

In some embodiments, the dimensions of each well are such that the fluid is retained in the well due capillary forces or surface tension forces.

In some embodiments, the bottom of each well is substantially flat.

In some embodiments, the rim is configured to be inserted into a well of a multiwell plate.

In some embodiments, the wells on the planar surface are distributed at regular intervals.

In some embodiments, the locations of the wells on the planar surface align with the locations of a plurality of wells of a multiwell plate.

In some embodiments, the multiwell plate comprises a configuration selected from the group consisting of 96-wells and 384-wells.

In some embodiments, the inversion plate is adapted for robotic manipulation.

In some embodiments, the fluid comprises a volume less than about 5 μl.

In some embodiments, the fluid comprises an aqueous solution.

In some embodiments, the fluid comprises a reagent for nucleic acid synthesis.

In some embodiments, the fluid comprises a polymerase.

In some embodiments, each well comprises the same fluid.

In some embodiments, at least two wells comprise different fluids.

In some embodiments, the well has a depth between about 8 mm and 12 mm.

In some embodiments, the well has a diameter between about 2.5 mm and 1.5 mm.

Some embodiments also include a lid configured to cover a plurality of the wells.

Some embodiments of the methods and compositions provided herein include an inversion plate kit comprising: any one of the inversion plates provided herein, wherein a plurality of the wells comprise a fluid reagent; and a lid configured to seal the wells of the inversion plate.

Some embodiments also include an alignment collar having an alignment element that aligns with the alignment element of the inversion plate.

Some embodiments also include a multiwell plate.

Some embodiments also include a collection tray.

Some embodiments of the methods and compositions provided herein include an apparatus for providing a fluid reagent to a multiwell plate comprising any one of the inversion plates provided herein; and an alignment collar comprising an alignment element coupled to the inversion plate, wherein the alignment collar comprises an alignment element aligned with the alignment element of the inversion plate.

Some embodiments also include a multiwell plate coupled to the inversion plate.

In some embodiments, the multiwell plate comprises an alignment element.

In some embodiments, the alignment element of the alignment collar aligns with the alignment element of the multiwell plate.

In some embodiments, the rim of each well inserts into each well of the multiwell plate.

Some embodiments of the methods and compositions provided herein include a method for providing a fluid reagent to a multiwell plate comprising: providing any one of the inversion plates provided herein, wherein each well comprises the fluid reagent; coupling the inversion plate with a multiwell plate such that the rim of each well of the inversion plate is aligned with each well of the multiwell plate; and applying a force to the inversion plate such that the fluid reagent is transferred to the multiwell plate.

In some embodiments, coupling the inversion plate with the multiwell plate is such that the rim of each well of the inversion plate is inserted into each well of the multiwell plate.

In some embodiments, the coupling comprises contacting the inversion plate and multiwell plate with an alignment collar having an alignment element.

Some embodiments also include aligning the alignment element of the inversion plate with an alignment element of the alignment collar

In some embodiments, applying a force comprises centrifuging the inversion plate coupled to the multiwell plate.

Some embodiments of the methods and compositions provided herein include a method for processing a plurality of reactions concurrently comprising: providing any one of the inversion plates provided herein, wherein each well comprises a fluid reagent; coupling the inversion plate with a multiwell plate such that the rims of a plurality of the wells of the inversion plate are aligned with a plurality of the wells of the multiwell plate; applying a force to the inversion plate such that the fluid reagent is transferred from the wells of the inversion plate to the wells of the multiwell plate; allowing a plurality of reactions to occur in the plurality of the wells of the multiwell plate, thereby obtaining reactants; and removing the reactants from the multiwell plate to a collection tray.

In some embodiments, coupling the inversion plate with the multiwell plate is such that the rims of a plurality of the wells of the inversion plate are inserted into the plurality of the wells of the multiwell plate.

In some embodiments, removing the reactants comprises: coupling the multiwell plate to a collection tray; and applying a force to the multiwell plate coupled to the collection tray such that the reactants are transferred from the wells of the multiwell plate to the wells of the multiwell plate.

In some embodiments, coupling the inversion plate with a multiwell plate comprises contacting the inversion plate and multiwell plate with an alignment collar.

Some embodiments also include aligning the alignment element of the inversion plate with an alignment element of the alignment collar

In some embodiments, applying a force to the inversion plate comprises centrifuging the inversion plate coupled to the multiwell plate.

In some embodiments, applying a force to the multiwell plate comprises centrifuging the inversion plate coupled to the multiwell plate.

In some embodiments, applying a force to the inversion plate comprises vibrating the inversion plate coupled to the multiwell plate.

Some embodiments of the methods and compositions provided herein include a system for processing a plurality of reactions concurrently comprising: a multiwell plate for performing a plurality of reactions, wherein the multiwell plate comprises a plurality of wells; any one of the inversion plates provided herein, wherein the inversion plate provides a fluid reagent to the plurality of wells of the multiwell plate; an alignment collar comprising an alignment element configured to align the wells of the multiwell plate with the wells of the inversion plate; and a collection tray configured to receive fluid reaction products from the plurality of wells of the multiwell plate multiwell plate.

In some embodiments, the multiwell plate is selected from the group consisting of consisting of a 96-well plate and a 384-well plate.

In some embodiments, the collection tray is configured to receive the multiwell plate

In some embodiments, the collection tray is configured to be centrifuged, wherein the collection tray is coupled to the multiwell plate.

In some embodiments, the collection tray is configured to be vibrated, wherein the collection tray is coupled to the multiwell plate.

Some embodiments include an inversion plate for providing fluid reagent to a multiwell plate, the inversion plate comprising: a planar surface having a plurality of sites distributed thereon, wherein each site comprises a well having a rim raised above the planar surface, wherein each well is configured such that a fluid is retained in the well when the planar surface is inverted; and an alignment element configured to align with an alignment element of an alignment collar or an alignment element on a multiwell plate.

In some embodiments, the dimensions of each well are such that the fluid is retained in the well due capillary forces or surface tension forces. In some embodiments, the bottom of each well is substantially flat.

In some embodiments, the rim is configured to be inserted into a well of a multiwell plate.

In some embodiments, the wells on the planar surface are distributed at regular intervals. In some embodiments, the locations of the wells on the planar surface align with the locations of a plurality of wells of a multiwell plate. In some embodiments, the multiwell plate comprises a configuration selected from the group consisting of 96-wells and 384-wells.

In some embodiments, the inversion plate is adapted for robotic manipulation.

In some embodiments, the fluid comprises a volume less than about 5 μl. In some embodiments, the fluid comprises an aqueous solution. In some embodiments, the fluid comprises a reagent for nucleic acid synthesis. In some embodiments, the fluid comprises a polymerase. In some embodiments, each well comprises the same fluid. In some embodiments, at least two wells comprise different fluids.

In some embodiments, the well has a depth between about 8 mm and 12 mm. In some embodiments, the well has a diameter between about 2.5 mm and 1.5 mm.

Some embodiments also include a lid configured to cover a plurality of the wells.

Some embodiments include an inversion plate kit comprising: the inversion plate of any one of the foregoing embodiments, wherein a plurality of the wells comprises a fluid reagent; and a lid configured to seal the wells of the inversion plate. Some embodiments also include an alignment collar having an alignment element that aligns with the alignment element of the inversion plate. Some embodiments also include a multiwell plate. Some embodiments also include a collection tray.

Some embodiments include an apparatus for providing a fluid reagent to a multiwell plate comprising: the inversion plate of any one of the foregoing embodiments; and an alignment collar comprising an alignment element coupled to the inversion plate, wherein the alignment collar comprises an alignment element aligned with the alignment element of the inversion plate. Some embodiments also include a multiwell plate coupled to the inversion plate. In some embodiments, the multiwell plate comprises an alignment element. In some embodiments, the alignment element of the alignment collar aligns with the alignment element of the multiwell plate. In some embodiments, the rim of each well inserts into each well of the multiwell plate.

Some embodiments include a method for providing a fluid reagent to a multiwell plate comprising: providing the inversion plate of any one of the foregoing embodiments, wherein each well comprises the fluid reagent; coupling the inversion plate with a multiwell plate such that the rim of each well of the inversion plate is aligned with each well of the multiwell plate; and applying a force to the inversion plate such that the fluid reagent is transferred to the multiwell plate.

In some embodiments, coupling the inversion plate with the multiwell plate is such that the rim of each well of the inversion plate is inserted into each well of the multiwell plate. In some embodiments, the coupling comprises contacting the inversion plate and multiwell plate with an alignment collar having an alignment element.

Some embodiments also include aligning the alignment element of the inversion plate with an alignment element of the alignment collar

In some embodiments, the applying a force comprises centrifuging the inversion plate coupled to the multiwell plate.

Some embodiments include a method for processing a plurality of reactions concurrently comprising: providing the inversion plate of any one of the foregoing embodiments, wherein each well comprises a fluid reagent; coupling the inversion plate with a multiwell plate such that the rims of a plurality of the wells of the inversion plate are aligned with a plurality of the wells of the multiwell plate; applying a force to the inversion plate such that the fluid reagent is transferred from the wells of the inversion plate to the wells of the multiwell plate; allowing a plurality of reactions to occur in the plurality of the wells of the multiwell plate, thereby obtaining reactants; and removing the reactants from the multiwell plate to a collection tray.

In some embodiments, coupling the inversion plate with the multiwell plate is such that the rims of a plurality of the wells of the inversion plate are inserted into the plurality of the wells of the multiwell plate. In some embodiments, removing the reactants comprises: coupling the multiwell plate to a collection tray; and applying a force to the multiwell plate coupled to the collection tray such that the reactants are transferred from the wells of the multiwell plate to the wells of the multiwell plate. In some embodiments, coupling the inversion plate with a multiwell plate comprises contacting the inversion plate and multiwell plate with an alignment collar.

Some embodiments also include aligning the alignment element of the inversion plate with an alignment element of the alignment collar

In some embodiments, applying a force to the inversion plate comprises centrifuging the inversion plate coupled to the multiwell plate. In some embodiments, applying a force to the multiwell plate comprises centrifuging the inversion plate coupled to the multiwell plate. In some embodiments, applying a force to the inversion plate comprises vibrating the inversion plate coupled to the multiwell plate.

Some embodiments include a system for processing a plurality of reactions concurrently comprising: a multiwell plate for performing a plurality of reactions, wherein the multiwell plate comprises a plurality of wells; the inversion plate of any one of the foregoing embodiments, wherein the inversion plate provides a fluid reagent to the plurality of wells of the multiwell plate; an alignment collar comprising an alignment element configured to align the wells of the multiwell plate with the wells of the inversion plate; and a collection tray configured to receive fluid reaction products from the plurality of wells of the multiwell plate multiwell plate.

In some embodiments, the multiwell plate is selected from the group consisting of consisting of a 96-well plate and a 384-well plate.

In some embodiments, the collection tray is configured to receive the multiwell plate. In some embodiments, the collection tray is configured to be centrifuged, wherein the collection tray is coupled to the multiwell plate. In some embodiments, the collection tray is configured to be vibrated, wherein the collection tray is coupled to the multiwell plate.

Some embodiments include a delivery plate for providing fluid reagent to a multiwell plate, the delivery plate comprising a plurality of wells, each well having a storage opening and an exit opening with a sidewall extending therebetween, wherein the sidewall comprises a constriction forming a storage chamber between the storage opening and the constriction and an exit chamber between the exit opening and the constriction, the constriction configured such that a fluid can be retained in the storage chamber and can be moved through the constriction to the exit chamber on application of a force.

In some embodiments, at least one opening of a well comprises a rim raised above a surface of the plate. In some embodiments, the rim is configured to be inserted into the well of a multiwell plate.

Some embodiments also an alignment element configured to align with an alignment element on a multiwell plate.

In some embodiments, the dimensions of the constriction are such that the fluid is retained in the storage chamber of the well due capillary forces or surface tension forces.

In some embodiments, the constriction comprises an open aperture having a radius of at least about 10 μm. In some embodiments, the constriction comprises an open aperture having a radius of at least about 100 μm. In some embodiments, the storage chamber has a depth from the storage opening to the constriction of at least about 100 μm. In some embodiments, the storage chamber has a depth from the storage opening to the constriction of at least about 500 μm. In some embodiments, the storage chamber has a depth from the storage opening to the constriction of at least about 2000 μm. In some embodiments, the exit chamber has a depth from the exit opening to the constriction of at least about 100 μm. In some embodiments, the exit chamber has a depth from the exit opening to the constriction of at least about 500 μm. In some embodiments, the exit chamber has a depth from the exit opening to the constriction of at least about 2000 μm.

In some embodiments, the locations of the wells align with the locations of a plurality of wells of a multiwell plate. In some embodiments, the multiwell plate comprises a configuration selected from the group consisting of 96-wells and 384-wells.

Some embodiments include a delivery plate of any one of the foregoing embodiments adapted for robotic manipulation.

In some embodiments, the fluid comprises a volume less than about 5 μl. In some embodiments, the fluid comprises an aqueous solution. In some embodiments, the fluid comprises a reagent for nucleic acid synthesis. In some embodiments, the fluid comprises a polymerase. In some embodiments, each well comprises the same fluid. In some embodiments, at least two wells comprise different fluids.

Some embodiments also include a lid configured to cover a plurality of storage openings of the wells. Some embodiments also include a lid configured to cover a plurality of exit openings of the wells.

In some embodiments, the storage chamber of each well comprises a fluid.

Some embodiments include a delivery plate kit comprising: the delivery plate of any one of the foregoing embodiments, wherein a plurality of the wells comprises a fluid reagent; and a lid configured to seal the wells of the delivery plate. Some embodiments also include the inversion plate kit of any one of the foregoing embodiments. Some embodiments also include an alignment collar having an alignment element that aligns with the alignment element of the delivery plate. Some embodiments also include a multiwell plate. Some embodiments also include a collection tray. In some embodiments, the storage chamber of each well comprises a fluid.

Some embodiments include an apparatus for providing a fluid reagent to a multiwell plate comprising: the delivery plate of any one of the foregoing embodiments; and an alignment collar comprising an alignment element coupled to the inversion plate, wherein the alignment collar comprises an alignment element aligned with the alignment element of the delivery plate. Some embodiments also include a multiwell plate coupled to the delivery plate. In some embodiments, the multiwell plate comprises an alignment element. In some embodiments, the alignment element of the alignment collar aligns with the alignment element of the multiwell plate. In some embodiments, the rim of each well inserts into each well of the multiwell plate. In some embodiments, the storage chamber of each well comprises a fluid.

Some embodiments include a method for providing a fluid reagent to a multiwell plate comprising: providing the delivery plate of any one of claims 45-69, wherein at least one well comprises the fluid reagent; coupling the delivery plate with a multiwell plate such that the exit opening of each well of the delivery plate is aligned with each well of the multiwell plate; and applying a force to the delivery plate such that the fluid reagent is transferred to the multiwell plate. In some embodiments, the storage chamber of each well comprises a fluid. In some embodiments, the exit opening of each well of the delivery plate comprises a rim, wherein coupling the delivery plate with the multiwell plate is such that the rim of the exit opening of each well of the delivery plate is inserted into each well of the multiwell plate. In some embodiments, the applying a force comprises centrifuging the delivery plate coupled to the multiwell plate. In some embodiments, applying a force to the delivery plate transfers the fluid from the storage chamber to the exit chamber.

Some embodiments include a method for providing a fluid reagent to a multiwell plate comprising: providing the delivery plate of any one of the foregoing embodiments; coupling the delivery plate with a multiwell plate such that the exit opening of each well of the delivery plate is aligned with each well of the multiwell plate; dispensing a fluid to a plurality of storage chambers of the delivery plate; and applying a force to the delivery plate such that the fluid reagent is transferred to the multiwell plate. In some embodiments, the exit opening of each well of the delivery plate comprises a rim, wherein coupling the delivery plate with the multiwell plate is such that the rim of the exit opening of each well of the delivery plate is inserted into each well of the multiwell plate. In some embodiments, the applying a force comprises centrifuging the delivery plate coupled to the multiwell plate. In some embodiments, applying a force to the delivery plate transfers the fluid from the storage chamber to the exit chamber.

Some embodiments include a method for processing a plurality of reactions concurrently comprising: providing the delivery plate of any one of the foregoing embodiments, wherein each well comprises a fluid reagent, and each exit opening comprises a rim; coupling the delivery plate with a multiwell plate such that the rims of a plurality of the wells of the delivery plate are aligned with a plurality of the wells of the multiwell plate; applying a force to the delivery plate such that the fluid reagent is transferred from the wells of the delivery plate to the wells of the multiwell plate; and providing conditions sufficient for a plurality of reactions to occur in the plurality of the wells of the multiwell plate, thereby obtaining reactants. In some embodiments, coupling the delivery plate with the multiwell plate is such that the rims of a plurality of the wells of the delivery plate are inserted into the plurality of the wells of the multiwell plate.

Some embodiments include a method for processing a plurality of reactions concurrently comprising: providing the delivery plate of any one of the foregoing embodiments, wherein at least one exit opening comprises a rim; coupling the delivery plate with a multiwell plate such that the rims of a plurality of the wells of the delivery plate are aligned with a plurality of the wells of the multiwell plate; dispensing a fluid to a plurality of storage chambers of the delivery plate; applying a force to the delivery plate such that the fluid reagent is transferred from the wells of the delivery plate to the wells of the multiwell plate; and providing conditions sufficient for a plurality of reactions to occur in the plurality of the wells of the multiwell plate, thereby obtaining reactants. In some embodiments, coupling the delivery plate with the multiwell plate is such that the rims of a plurality of the wells of the delivery plate are inserted into the plurality of the wells of the multiwell plate. In some embodiments, applying a force to the delivery plate comprises centrifuging the delivery plate coupled to the multiwell plate. In some embodiments, applying a force to the delivery plate comprises vibrating the delivery plate coupled to the delivery plate.

### BRIEF DESCRIPTION OF THE DRAWINGS

FIG. 1 depicts an embodiment of an inversion plate.

FIG. 2 depicts a top-down view of the inversion plate of FIG. 1.

FIG. 3 depicts a bottom-up view of the inversion plate of FIG. 1.

FIG. 4 depicts a transverse section of a side view of the longer edge of the inversion of FIG. 1.

FIG. 5 depicts a side view of the longer length of the inversion plate of FIG. 1.

FIG. 6 depicts an end view of the shorter length of the inversion plate of FIG. 1.

FIG. 7 depicts an end view of the shorter length of the inversion plate of FIG. 1.

FIG. 8 depicts an embodiment of an alignment collar.

FIG. 9 depicts a top-down view of the alignment collar of FIG. 8.

FIG. 10 depicts a bottom-up view of the alignment collar of FIG. 8.

FIG. 11 depicts an embodiment in which an inversion plate is aligned over an alignment collar, and the alignment collar is aligned over a multiwell plate.

FIG. 12 depicts an embodiment of an assembled device for providing a fluid reagent to a multiwell plate in which an inversion plate, an alignment collar and a multiwell plate are coupled together.

FIG. 13 depicts an embodiment of a collection tray.

FIG. 14 depicts a top-down view of the collection tray of FIG. 13

FIG. 15 depicts a transverse section of a side view of the longer edge of the collection tray of FIG. 13.

FIG. 16 depicts a side view of the longer edge of the collection tray of FIG. 13.

FIG. 17 depicts a side view of the shorter edge of the collection tray of FIG. 13.

FIG. 18 depicts a side view of the shorter edge of the collection tray of FIG. 13.

FIG. 19 depicts an embodiment of an apparatus in which a multiwell plate is inverted and placed in a collection tray.

FIG. 20A depicts a plan view of an embodiment of a delivery plate coupled to a multiwell plate. FIG. 20B depicts a cross-section of the coupled delivery plate and a multiwell plate of FIG. 20A. FIG. 20C depicts a detailed view of the cross-section of the coupled delivery plate and a multiwell plate depicted in FIG. 20B. FIG. 20D depicts a delivery plate. FIG. 20E depicts a delivery plate aligned above a multiwall plate.

FIG. 21 depicts an embodiment of a delivery plate coupled to a multiwell plate.

FIG. 22 depicts an embodiment of a collection tray.

FIG. 23 depicts an embodiment of an inversion plate coupled to a collection tray.

FIG. 24 depicts an embodiment of a collection tray and an inversion plate.

### DETAILED DESCRIPTION

Some embodiments of the methods and compositions provided herein include plates for delivering fluid reagents. In some embodiments, such plates include inversion plates and delivery plates useful for the transfer of fluid reagents to multiwell plates.

Some of the methods and compositions provided herein include inversion plates. In some embodiments, such inversion plates are dimensioned such that a fluid reagent is retained in a well of the inversion plate when the plate is inverted. In addition, some embodiments of the inversion plates provided herein include wells having rims that may be inserted into a well of a multiwell plate, thereby providing efficient transfer of a fluid reagent from the inversion plate to the multiwell plate. In more embodiments, an inversion plate is aligned with a multiwell plate with an alignment collar.

Advantageously, the inversion plates and delivery plates provided herein are useful to transfer reagents from the wells of the inversion plate or delivery plate to the wells of a multiwell plate simultaneously. Simultaneous transfer of a reagent to all wells of multiwell plate comprising a sample is particularly useful in applications where all reactions in a multiwell plate are to begin at the same time. For example, application such as quantitative PCR may require all reactions in a multiwell plate to begin at the same time. In addition, the inversion plates and the delivery plates provided herein are useful for providing reagents for use in multiwell plates. In some embodiments, all fluid reagents are pre-distributed before use, thereby reducing user error. In addition, retention of a fluid reagent by the wells of the inversion plates provided herein reduces the risk of losing a volume of reagent on use of the inversion plate.

Some embodiments of the methods and compositions provided herein include the use of apparatus and components illustrated in U.S. Ser. No. 29/476713 entitled “INVERSION PLATE SLEEVE” filed Dec. 16, 2013; U.S. Ser. No. 29/476706 entitled “INVERSION PLATE” filed Dec. 16, 2013; U.S. Ser. No. 29/481209 entitled “REAGENT DISPENSING PLATE” filed Feb. 3, 2014; and U.S. Ser. No. 29/481117 entitled “COLLECTION PLATE” filed Jan. 31, 2014, the contents of each of the foregoing is incorporated by reference in its entirety.

### Inversion Plates and Delivery Plates

Some embodiments of the methods and compositions provided herein include an inversion plate or a delivery plate for providing fluid reagent to a multiwell plate. In some embodiments, an inversion plate comprises a plate having a plurality of wells, in which each well includes a fluid reagent. In some embodiments, a delivery plate comprises a plurality of wells, each well having a storage opening and an exit opening with a sidewall extending therebetween, wherein the sidewall comprises a constriction forming a storage chamber between the storage opening and the constriction and an exit chamber between the exit opening and the constriction, the constriction configured such that a fluid can be retained in the storage chamber and can be moved through the constriction to the exit chamber on application of a force.

In some embodiments, the fluid reagent may contain one component or more than one component. Further, the fluid reagent in each well may be the same or different. For example, each well may contain reagents for performing an amplification reaction such as a polymerase, dNTPs, buffer components and primers. However, one or more of the reaction components may differ from one well to another, for example each well may contain reagents for amplification except primer pairs may differ from one well to another well of the inversion plate. The inversion plate or delivery plate can be coupled to a multiwell plate such that the reagent from each well of the inversion plate or the delivery plate may be transferred directly to each corresponding well in the multiwell plate with minimal to no reagent loss.

### Inversion Plates

In some embodiments, an inversion plate can include a planar surface having a plurality of sites distributed thereon. In some embodiments, the sites are distributed at regular intervals on the planar surface. In some embodiments, the sites are distributed on the planar surface at locations that correspond to, or align with, the locations of wells in a multiwell plate. Multiwell plates include standardized dimensions for the spacing of wells on the surface of the multiwell plate. In some embodiments, multiwell plates include 96-wells, 384-wells, 1536-wells, 3456 wells, and 9600-wells.

In some embodiments, each site comprises a well with dimensions such that fluid is retained in the well when the inversion plate is inverted. Without being bound to any one theory, the fluid may be retained in the well by forces such as capillary forces and/or surface tension. In some embodiments, the well can have a shape that is cylindrical, substantially cylindrical, square-shaped, substantially square-shaped, straight-sided, substantially straight-sided, tapered to a wider bottom or a narrower bottom, substantially tapered to a wider bottom or a narrower bottom. In some embodiments, the well is substantially square-shaped. In some embodiments, the depth of the well is, is at least, or is less than, about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, about 3 mm, about 2 mm, about 1 mm, or a range defined by any two of the preceding values. In some embodiments, the well has a diameter that is, is at least, or is less than, about 5 mm, about 4.5 mm, about 4 mm, about 3.5 mm, about 3 mm, about 2.5 mm, about 2 mm, about 1.5 mm, about 1 mm, about 0.5 mm, or a range defined by any two of the preceding values. In some embodiments, the depth of the well is no deeper than any of the foregoing depths.

In some embodiments, each well includes a rim that is raised above the planar surface of the inversion plate. In some embodiments, the rim is dimensioned such that it may be inserted into the well of a multiwell plate. For example, an inversion plate can be coupled to a multiwell plate such that the rims of each well of the inversion plate are inserted into the wells of a multiwell plate to permit a close interaction between the wells of the two plates for providing efficient transfer of a fluid from the wells of the inversion plate to the wells of a multiwell plate. In some embodiments, the rim is dimensioned such that the top surface of the rim is flush with the top rim of a well of a multiwell plate. In some embodiments, the rim aligns with the rim of a well of a multiwell plate.

In some embodiments, an inversion plate is adapted for robotic manipulation. For example, the inversion plate can include indents, holes, pins, raised bumps or other structures for robotic handling and orientation.

In some embodiments, the inversion plate can include an alignment element. An alignment element can be useful to orientate the inversion plate to other plates, such as a multiwell plate and can be useful for robotic handling to locate particular sites or wells on the inversion plate. In some embodiments, an alignment element can include an inversion plate shaped such that the orientation of the inversion plate is apparent, for example, a regular-shaped inversion plate can have a ‘cut-off corner’ to signal the orientation of the inversion plate. Other structures useful as alignment elements include, but are not limited to, indents, holes, pins, frits and raised bumps.

In some embodiments, the inversion plate can include a lid. In some embodiments, the lid can seal or cover a fraction of the wells of the inversion plate. In some embodiments, a lid can seal or cover all wells of the inversion plate. The lid can include a solid, or substantially solid lid, or can include tape or sealing compositions.

In some embodiments, the inversion plate can include a fluid reagent. In some embodiments, the volume of the fluid reagent in a well is, is at least, or is less than, about 100 μl, about 90 μl, about 80 μl, about 70 μl, about 60 μl, about 50 μl, about 40 μl, about 30 μl, about 20 μl, about 10 μl, or a range defined by any two of the preceding values. In some embodiments, the volume of the fluid reagent in a well is, is at least, or is less than, about 10 μl, about 9 μl, about 8 μl, about 7 μl, about 6 μl, about 5 μl, about 4 μl, about 3 μl, about 2 μl, about 1 μl, or a range defined by any two of the preceding values. In some embodiments, the volume of the fluid reagent in a well is about 1 μl to about 700 μl, about 1 μl to about 500 μl, about 1 μl to about 100 μl, about 1 μl to about 50 μl, or about 1 μl to about 10 μl. In some embodiments, the fluid reagent comprises a solution, an aqueous solution, a gel, a slurry, or a powder. In some embodiments, the fluid reagent includes a reagent useful for obtaining nucleic acid information, for example, an enzyme, a polymerase, nucleotide, primer, or glycerol. In some embodiments, each well of the inversion plate can include the same fluid reagent. In some embodiments, at least two wells of an inversion plate can include different fluid reagents. In some embodiments, each well in an inversion plate can include a different fluid reagent. In some embodiments the fluid reagent in an inversion plate is lyophilized or dried down. The lyophilized or dried down components can be useful for inversion plate distribution purposes, for example when shipping an inversion plate from one location to another is desired. A lyophilized or dried down plate can be sealed with a lid, tape or other sealing device, the plate can be shipped to an individual whereupon the lyophilized or dried down reagent can be reconstituted, thereby provided an inversion plate for use in methods described herein.

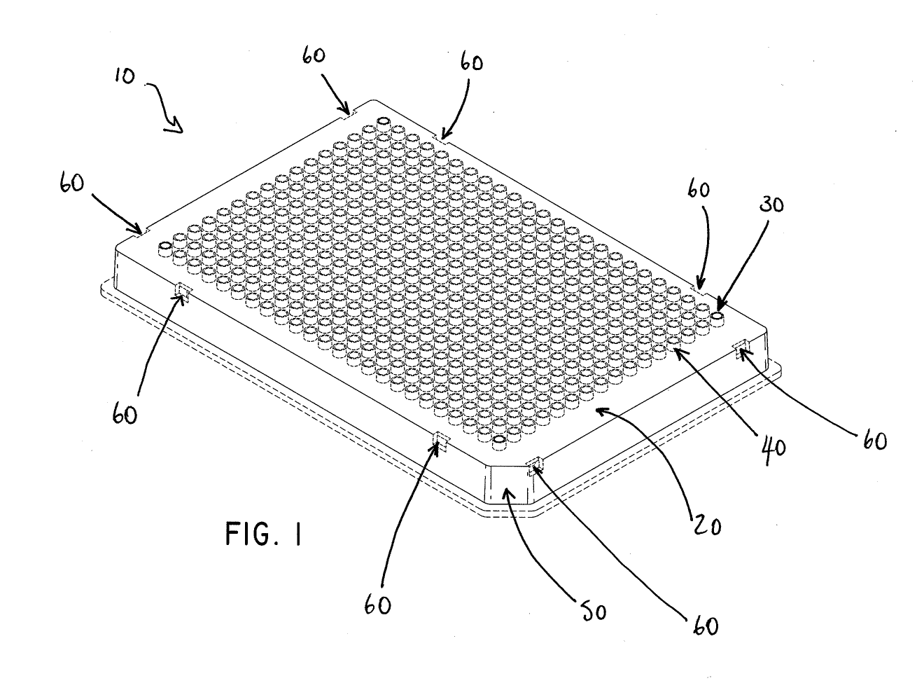

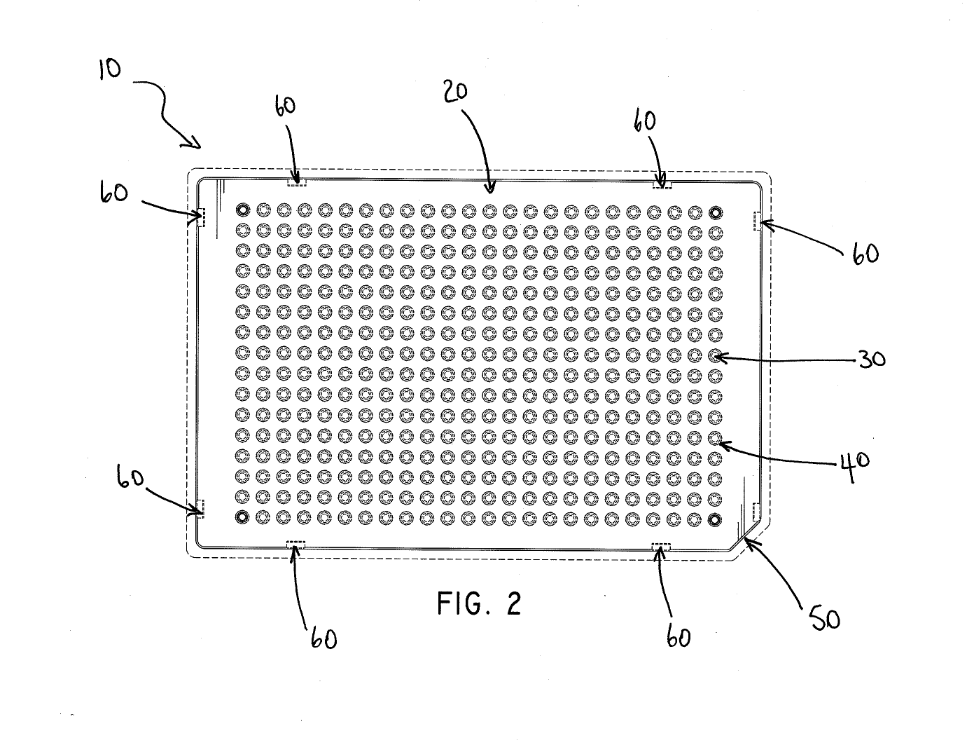

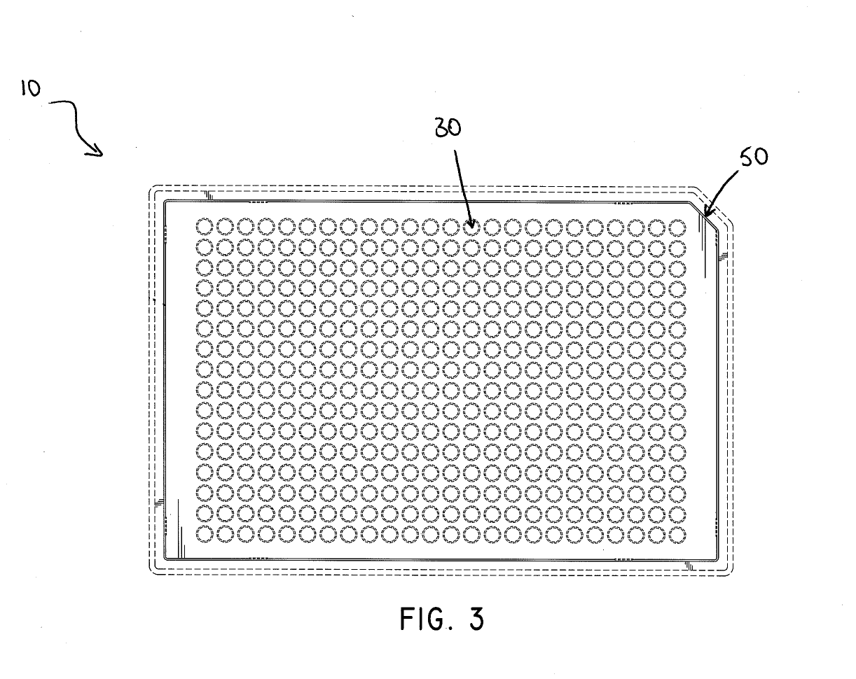

FIG. 1 shows an embodiment of an inversion plate 10. The inversion plate includes a planar surface 20 with a plurality of wells. The well 30 has a rim 40 raised above a surface of the inversion plate. The inversion plate includes an alignment element 50 which provides the inversion plate with an obvious orientation. The inversion plate also includes structures such as indents 60 for robotic manipulation of the inversion plate. FIG. 2 shows a top-down view of the inversion plate 10 of FIG. 1 with a planar surface having a plurality of wells with rims. FIG. 2 also shows the alignment 50 of the inversion plate, and indents 60 for robotic manipulation of the inversion plate. FIG. 3 shows a bottom-up view of the inversion plate 10 of FIG. 1 with well 30 and alignment element 50 shown.

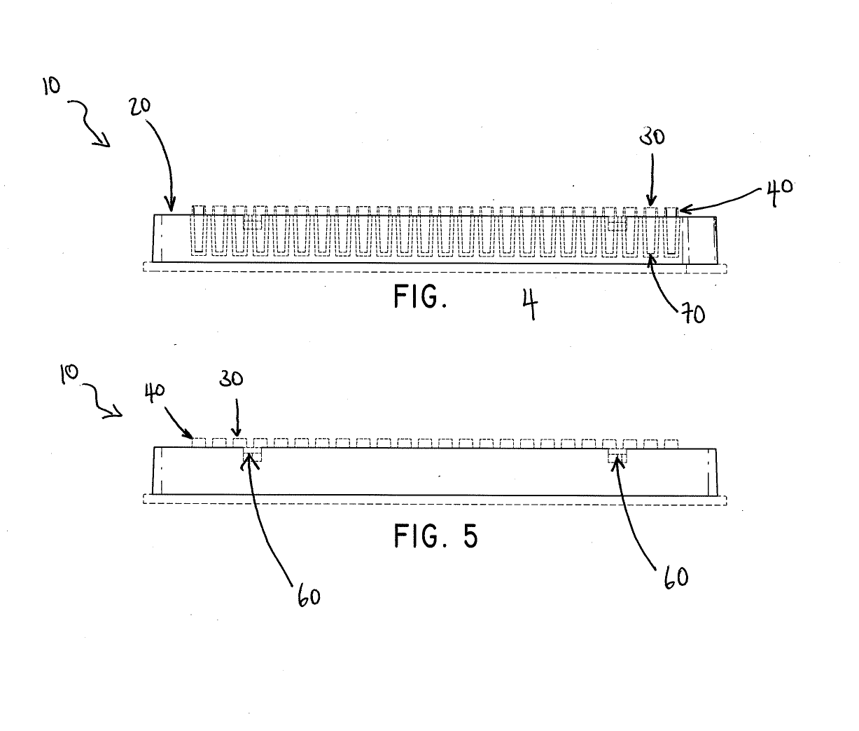

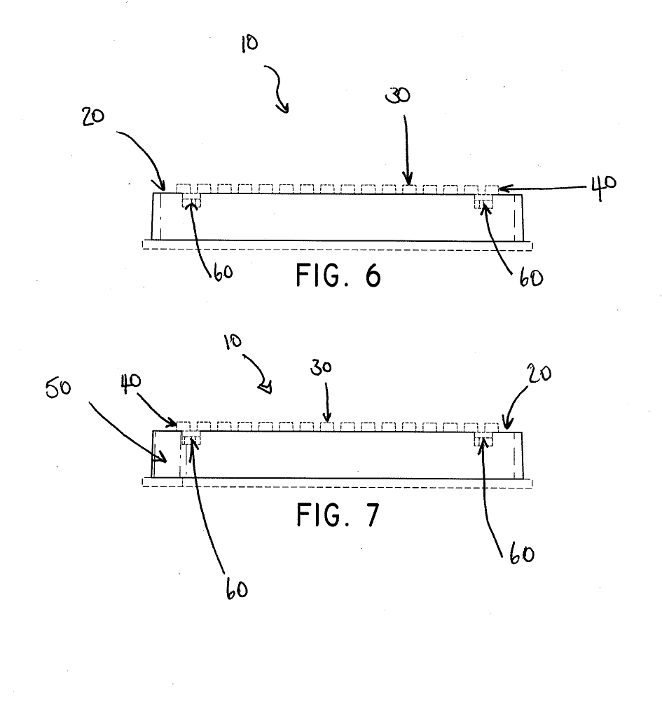

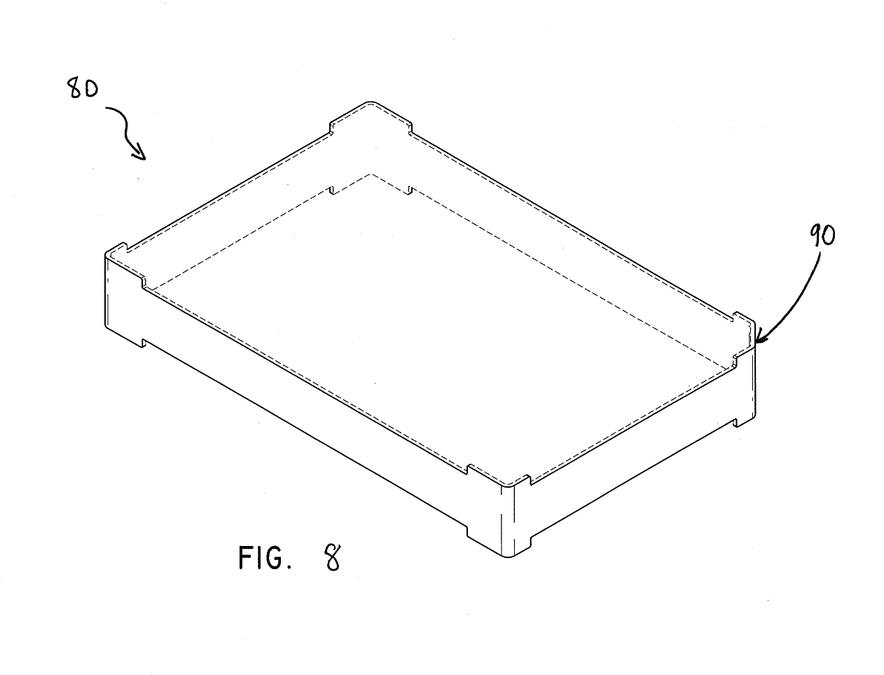

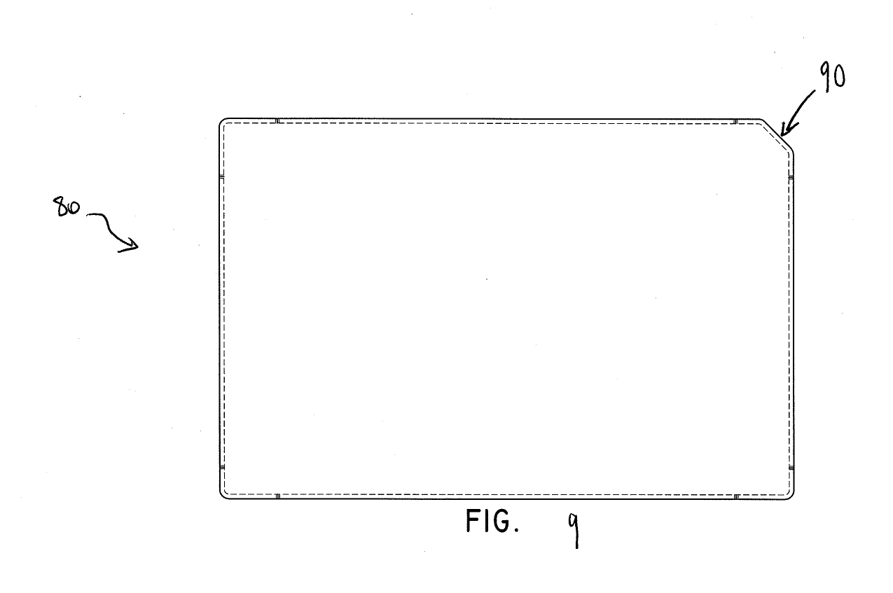

FIG. 4 shows a transverse section of a side view of the longer edge of the inversion plate 10 of FIG. 1. In this embodiment, the bottom 70 of each well 30 is substantially flat. The dimensions and shape of each well are sufficient to retain fluids in each well when the inversion plate is inverted. Without being bound to any one theory, the fluid in each well may be retained by forces such as capillary action and/or surface tension. FIG. 5 shows a side view of the longer length of the inversion plate 10 of FIG. 1 in which the raised rim 40 of a well 30 is shown, and an indent 60 for robotic manipulation of the inversion plate. FIG. 6 and FIG. 7 each show an end view of the shorter edge of the inversion plate 10 of FIG. 1. FIG. 6 and FIG. 7 each show the planar surface 10, a well 30, the raised rim 40 of a well, and an indent 60 for robotic manipulation of the plate. FIG. 7 also shows the alignment element 50.

### Delivery Plates

In some embodiments, a delivery plate can include a planar substrate comprising a plurality of wells, each well having a storage opening and an exit opening with a sidewall extending therebetween. The storage opening and exit opening can be on opposite sides of a substrate having two surfaces. The sidewall can include a constriction that forms a storage chamber between the storage opening and the constriction, and an exit chamber between the exit opening and the constriction. The constriction can include an open aperture such that the storage chamber and exit chamber are in fluid communication. The constriction can be configured such that a fluid can be retained in the storage chamber and can be moved through the constriction to the exit chamber on application of a force. Without being bound to any one theory, the fluid may be retained in the storage chamber by forces such as capillary forces and/or surface tension.

In some embodiments, the openings are distributed at regular intervals on the planar substrate. In some embodiments, the wells, including the exit openings, are distributed on the planar substrate at locations that correspond to, or align with, the locations of wells in a multiwell plate.

In some embodiments, the exit opening of each well includes a rim that is raised above a surface of the delivery plate. In some embodiments, the storage opening of each well includes a rim that is raised above a surface of the delivery plate. In some embodiments, the rim is dimensioned such that it may be inserted into the well of a multiwell plate. For example, a delivery plate can be coupled to a multiwell plate such that the rims of each well of the delivery plate, such as the rims of the exit openings, are inserted into the wells of a multiwell plate to permit a close interaction between the wells of the two plates for providing efficient transfer of a fluid from the wells of the delivery plate to the wells of a multiwell plate. In some embodiments, the rim is dimensioned such that the top surface of the rim is flush with the top rim of a well of a multiwell plate. In some embodiments, the rim aligns with the rim of a well of a multiwell plate.

In some embodiments, a delivery plate is adapted for robotic manipulation. For example, the delivery plate can include indents, holes, pins, raised bumps or other structures for robotic handling and orientation.

In some embodiments, the delivery plate can include an alignment element. An alignment element can be useful to orientate the inversion plate to other plates, such as a multiwell plate and can be useful for robotic handling to locate particular sites or wells on the delivery plate. In some embodiments, an alignment element can include an delivery plate shaped such that the orientation of the delivery plate is apparent, for example, a regular-shaped inversion plate can have a ‘cut-off corner’ to signal the orientation of the delivery plate. Other structures useful as alignment elements include, but are not limited to, indents, holes, pins, frits and raised bumps.

In some embodiments, the delivery plate can include a lid. In some embodiments, the lid can seal or cover a fraction of the wells of the delivery plate. In some embodiments, a lid can seal or cover all wells of the inversion plate. The lid can include a solid, or substantially solid lid, or can include tape or sealing compositions. In some embodiments, the lid can seal a plurality of the exit openings of the plate. In some embodiments, the lid can seal a plurality of the storage openings of the plate.

In some embodiments, the delivery plate can include a fluid reagent. In some such embodiments, the storage chamber of the well can include a fluid reagent. In some embodiments, the volume of the fluid reagent in a well is, is at least, or is less than, about 700 μl, about 500 μl, about 100 μl, about 90 μl, about 80 μl, about 70 μl, about 60 μl, about 50 μl, about 40 μl, about 30 μl, about 20 μl, about 10 μl, or a range defined by any two of the preceding values. In some embodiments, the volume of the fluid reagent in a well is, is at least, or is less than, about 10 μl, about 9 μl, about 8 μl, about 7 μl, about 6 μl, about 5 μl, about 4 μl, about 3 μl, about 2 μl, about 1 μl, or a range defined by any two of the preceding values. In some embodiments, the volume of the fluid reagent in a well is about 1 μl to about 700 μl, about 1 μl to about 500 μl, about 1 μl to about 100 μl, about 1 μl to about 50 μl, or about 1 μl to about 10 μl. In some embodiments, the fluid reagent comprises a solution, an aqueous solution, a gel, a slurry, or a powder. In some embodiments, the fluid reagent includes a reagent useful for obtaining nucleic acid information, for example, an enzyme, a polymerase, nucleotide, primer, or glycerol. In some embodiments, each well of the delivery plate can include the same fluid reagent. In some embodiments, at least two wells of a delivery plate can include different fluid reagents. In some embodiments, each well in a delivery plate can include a different fluid reagent. In some embodiments the fluid reagent in a delivery plate is lyophilized or dried down. The lyophilized or dried down components can be useful for delivery plate distribution purposes, for example when shipping a delivery plate from one location to another is desired. A lyophilized or dried down plate can be sealed with a lid, tape or other sealing device, the plate can be shipped to an individual whereupon the lyophilized or dried down reagent can be reconstituted, thereby provided a delivery plate for use in methods described herein.

In some embodiments, the constriction of well comprises an open aperture having a radius that is, is not more than, or is at least, about 1000 μm, about 500 μm, about 400 μm, about 300 μm, about 200 μm, about 100 μm, about 50 μm, about 40 μm, about 30 μm, about 20 μm, about 10 μm, about 5 μm, or within a range of any two of the foregoing dimensions.

In some embodiments, the storage chamber has a depth from the storage opening to the constriction that is, is not more than, or is at least, about 100 μm, about 200 μm, about 300 μm, about 400 μm, about 500 μm, about 600 μm, about 700 μm, about 800 μm, about 1000 μm, about 2000 μm, about 3000 μm, or within a range of any two of the foregoing dimensions. In some embodiments, the exit chamber has a depth from the exit opening to the constriction that is, is not more than, or is at least, about 100 μm, about 200 μm, about 300 μ, about 400 μm, about 500 μm, about 600 μm, about 700 μm, about 800 μm, about 1000 μm, about 2000 μm, about 3000 μm, or within a range of any two of the foregoing dimensions.

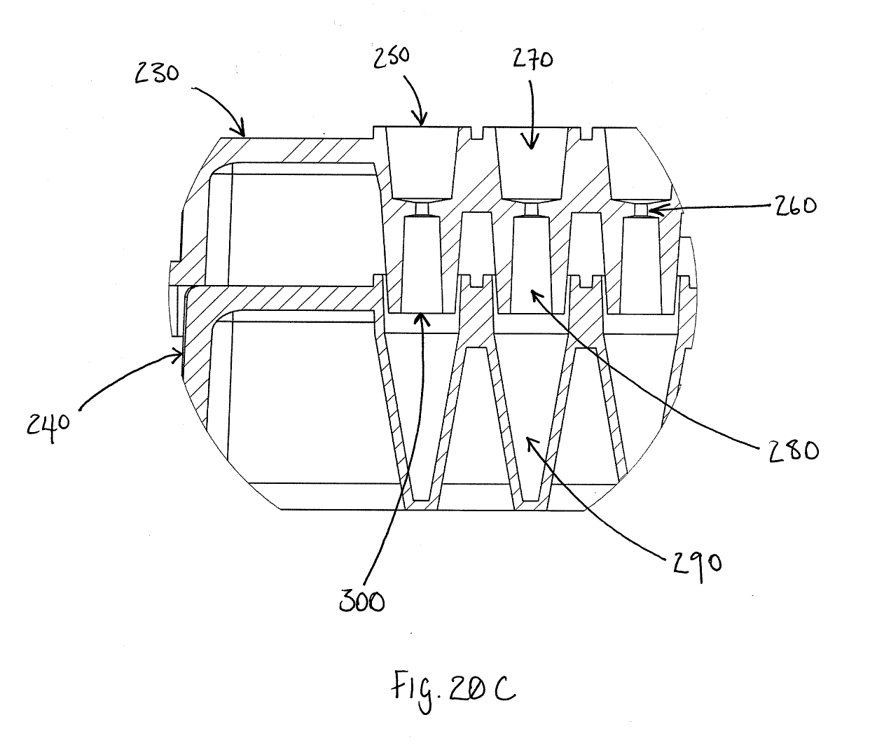

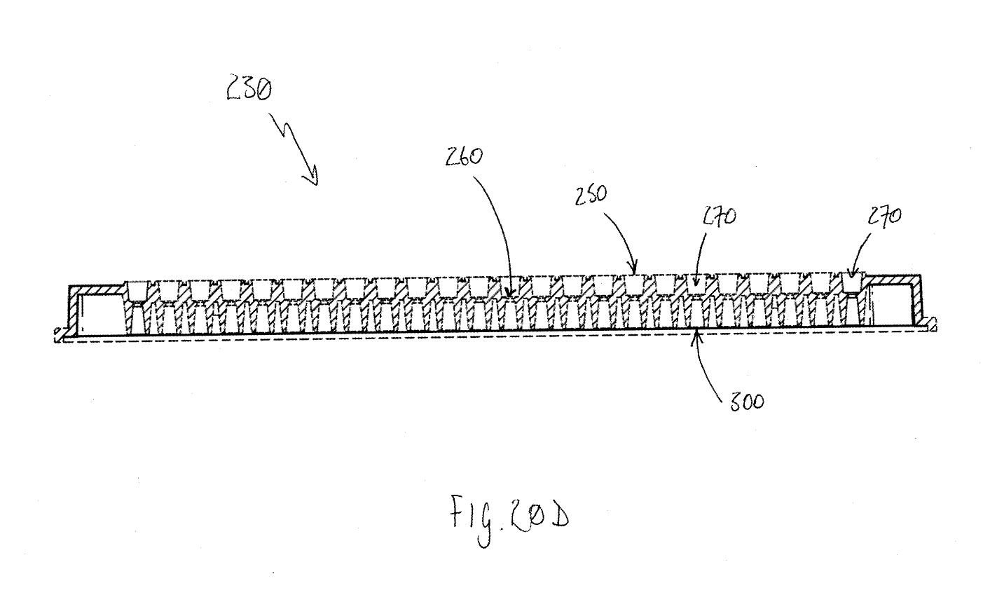

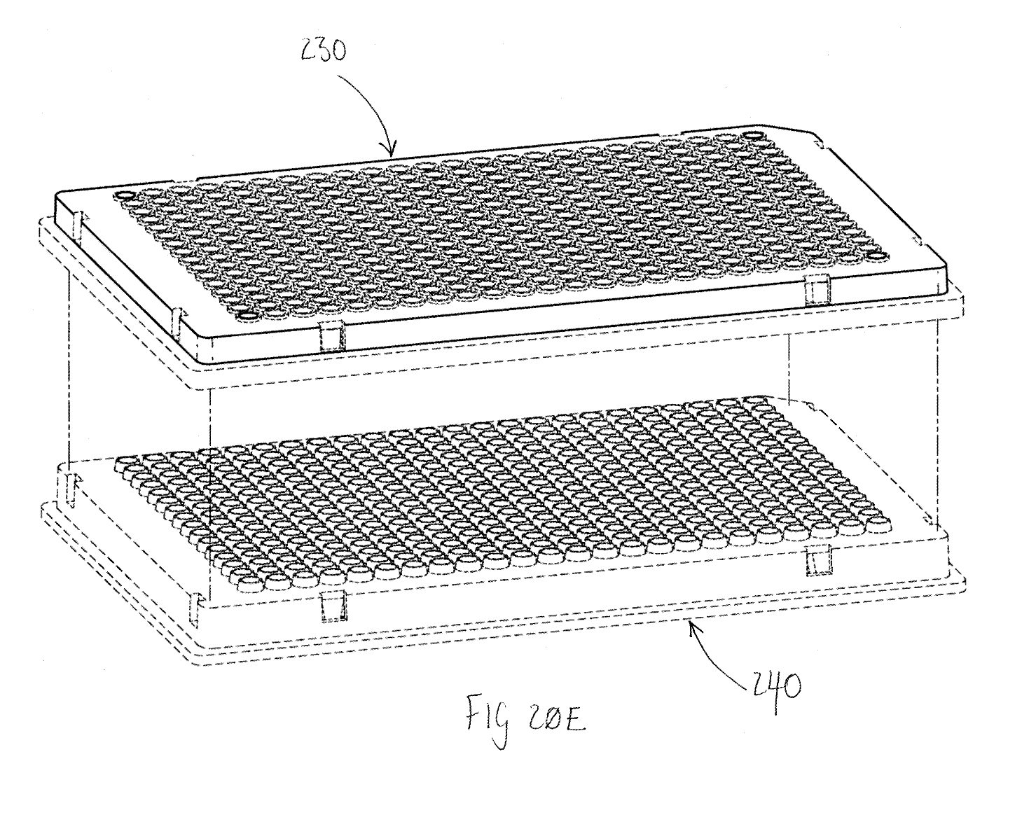

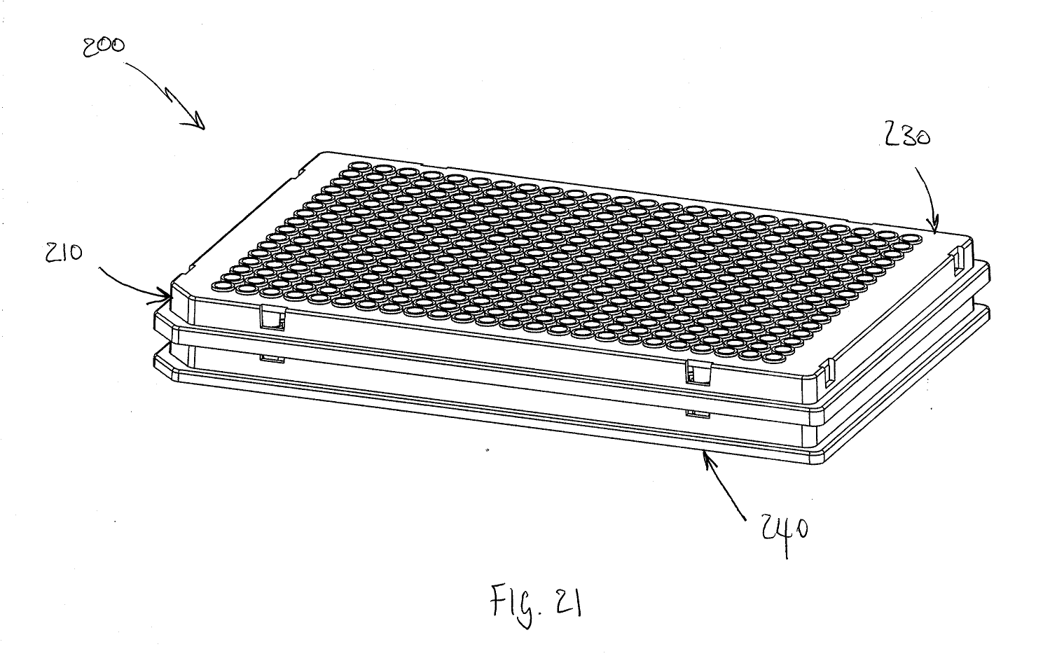

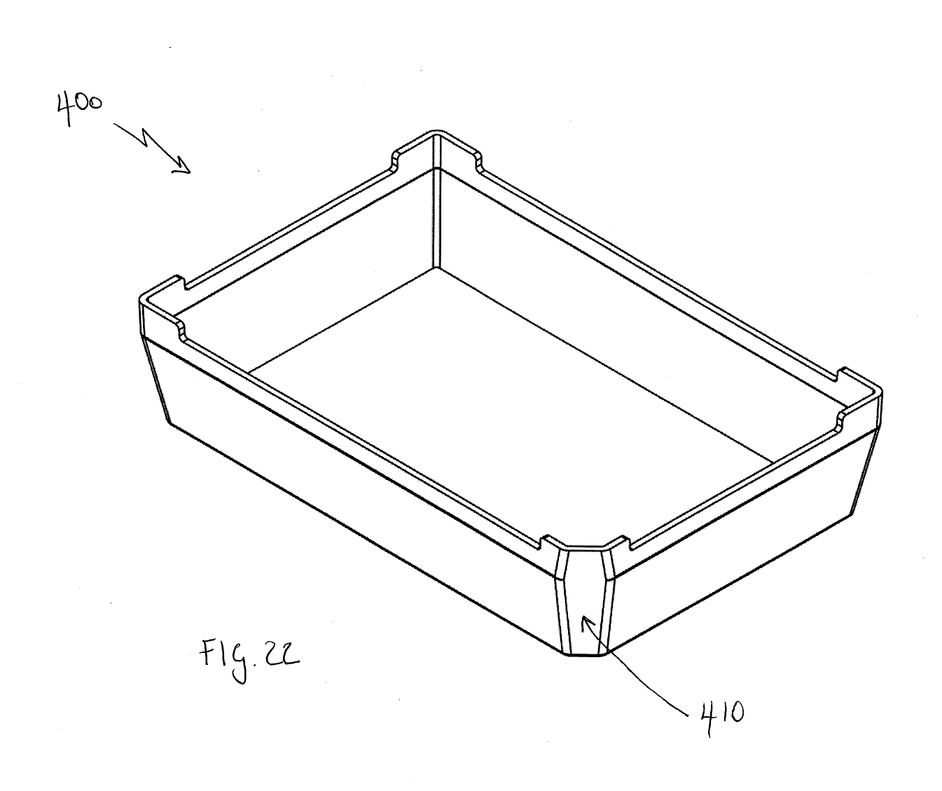

FIG. 20A depicts an embodiment showing a plan view of a delivery plate coupled to a multiwell plate 200. The delivery plate comprises a plurality of wells 220 which include a storage opening 250, and includes an alignment element 210. FIG. 20B depicts a cross-section of the coupled delivery plate 200 of FIG. 20A at ‘A’. The delivery plate 230 is coupled to multiwell plate 240. The delivery plate includes storage openings 250. FIG. 20C depicts detail of coupled delivery plate 200 of FIG. 20B at ‘B’. The delivery plate 230 is coupled to the multiwell plate 240. The well 220 of the delivery plate includes a storage opening 250 and storage chamber 270, a constriction 260 in the well wall, an exit chamber 280 and an exit opening 300. The storage chamber 270 and exit chamber 280 are in fluid communication with one another through an aperture in the constriction 260. The exit chamber is in fluid communication with the well 290 of the multiwell plate 240. FIG. 20D depicts delivery plate 230. FIG. 20E depicts a delivery plate 230 aligned above a multiwell plate 240. FIG. 21 depicts the coupled 200 delivery plate 230 and multiwell plate 240 with alignment element 210.

### Alignment Collars

Some embodiments of the methods and compositions provided herein include an alignment collar. An alignment collar is useful to align an inversion plate or a delivery plate with a multiwell plate. In some embodiments, an alignment collar can include a collar that wraps around an edge of an inversion plate or a delivery plate. In some embodiments, the alignment collar wraps around the edge of a multiwell plate. In some embodiments, the alignment collar guides the coupling of an inversion plate or a delivery plate with a multiwell plate. The alignment collar can include an alignment element that corresponds to an alignment element of the inversion plate or delivery plate such that the alignment collar couples to the inversion plate or delivery plate in a certain orientation. In some embodiments, the alignment collar can include an alignment element that corresponds to an alignment element of a multiwell plate such that the alignment collar couples to multiwell plate in a certain orientation. Examples of alignment elements include a ‘cut-off corner’ to signal the orientation of the inversion plate or delivery plate. Other structures useful as alignment elements include indents, holes, pins, frits and raised bumps.

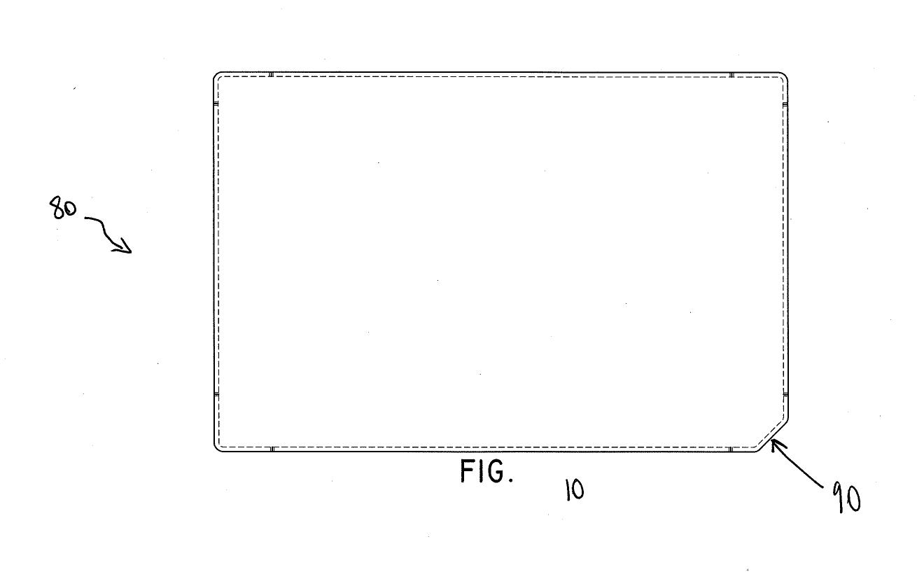

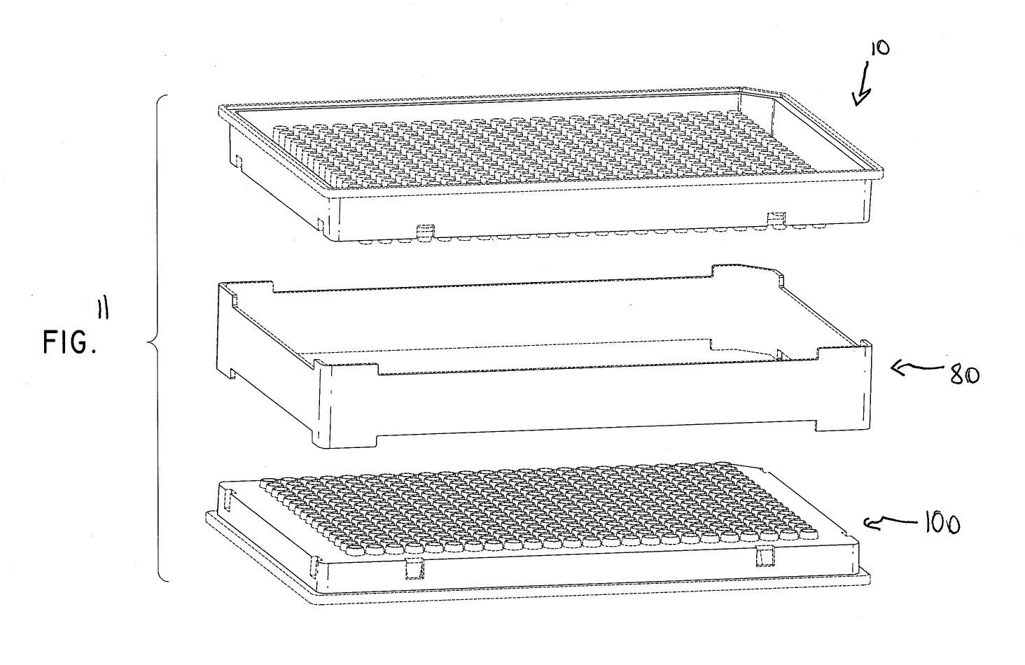

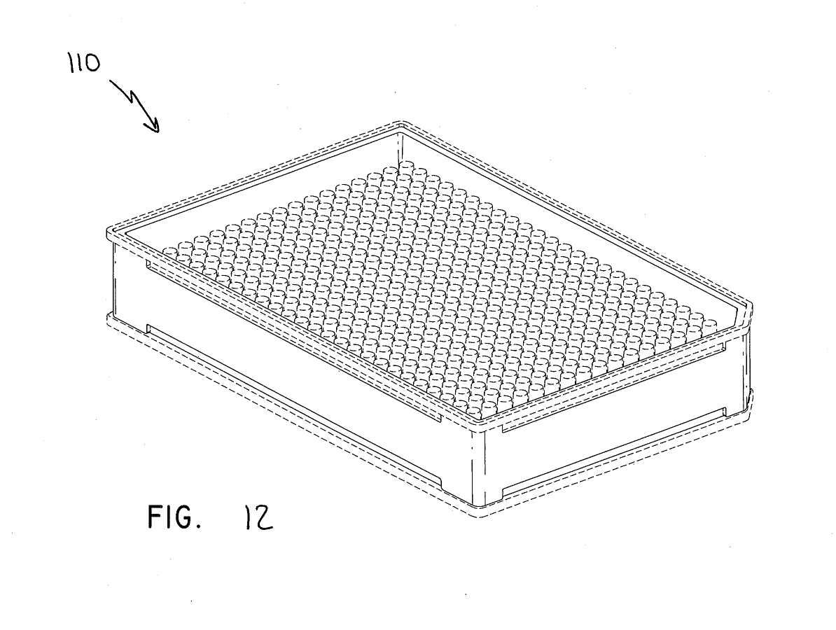

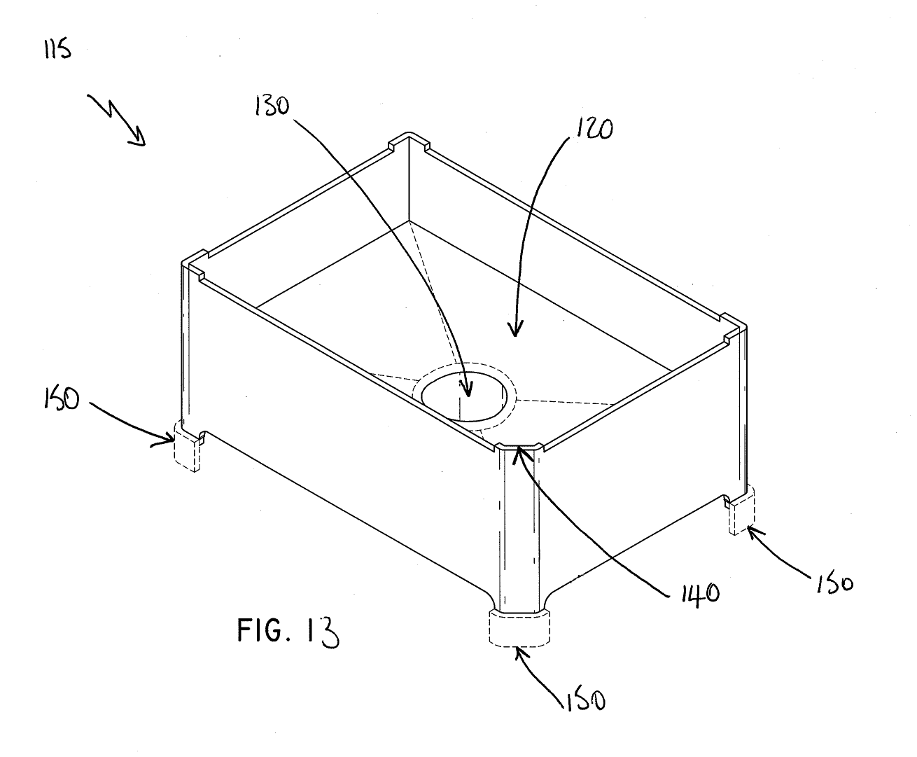

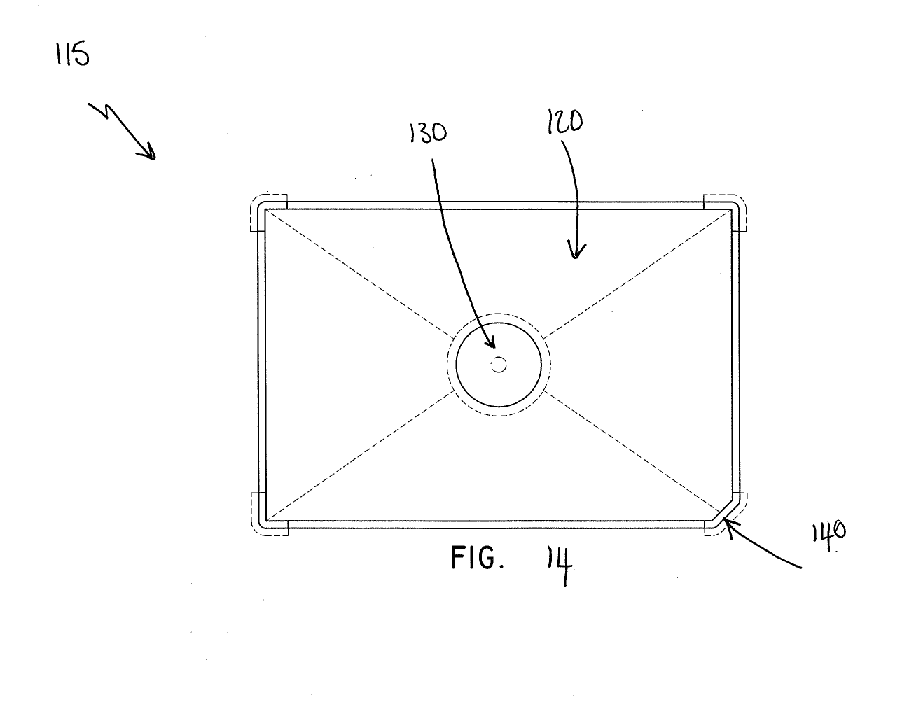

FIG. 8 shows an embodiment of an alignment collar 80. The alignment collar includes an alignment element 90. FIG. 9 is a top-down view of the alignment collar 80 having an alignment element 90. FIG. 10 is a bottom-up view of the alignment collar 80 having an alignment element 90. FIG. 11 shows an embodiment in which the orientation of an inversion plate 10 is aligned over an alignment collar 80, and the orientation of the alignment collar is aligned above a multiwell plate 100. FIG. 11 shows the opening of each well of the multiwell plate with a raised rim above the dorsal surface of the multiwell plate. In some embodiments, the opening of each well of the multiwell plate is flush with the dorsal surface of the multiwell plate. FIG. 12 shows an embodiment of an assembled device 110 for providing a fluid reagent to a multiwell plate in which the inversion plate 10 of FIG. 11, the alignment collar 80 of FIG. 11 and the multiwell plate 100 of FIG. 11 are shown coupled together.

### Collection Trays

Some embodiments of the methods and compositions provided herein include a collection tray. In some embodiments, a collection tray can be useful to pool the contents of the wells of a multiwell plate if it is desirable to combine the contents of more than one well of a multiwell plate. In some embodiments, a plurality of different reactions can be performed in a multiwell plate and the reaction products pooled in a collection tray for further processing. Examples of such reactions include methods of nucleic acid library synthesis, and nucleic acid sequencing.

In some embodiments, a collection tray comprises a structure in which a multiwell plate can be seated such that the contents of the multiwell will be transferred to the bottom surface of the collection tray. In some embodiments, the bottom surface of the collection tray is substantially flat. In other embodiments the bottom surface of the collection tray is sloped. In some embodiments, the bottom surface of the collection tray is sloped to a collection cup in the center of the bottom surface. The collection cup can be of any geometry, for example conical, round, square, etc. The collection tray can include structures configured such that a plurality of collection trays may be stacked. Examples of such structures include stackable feet on the bottom of a collection tray.

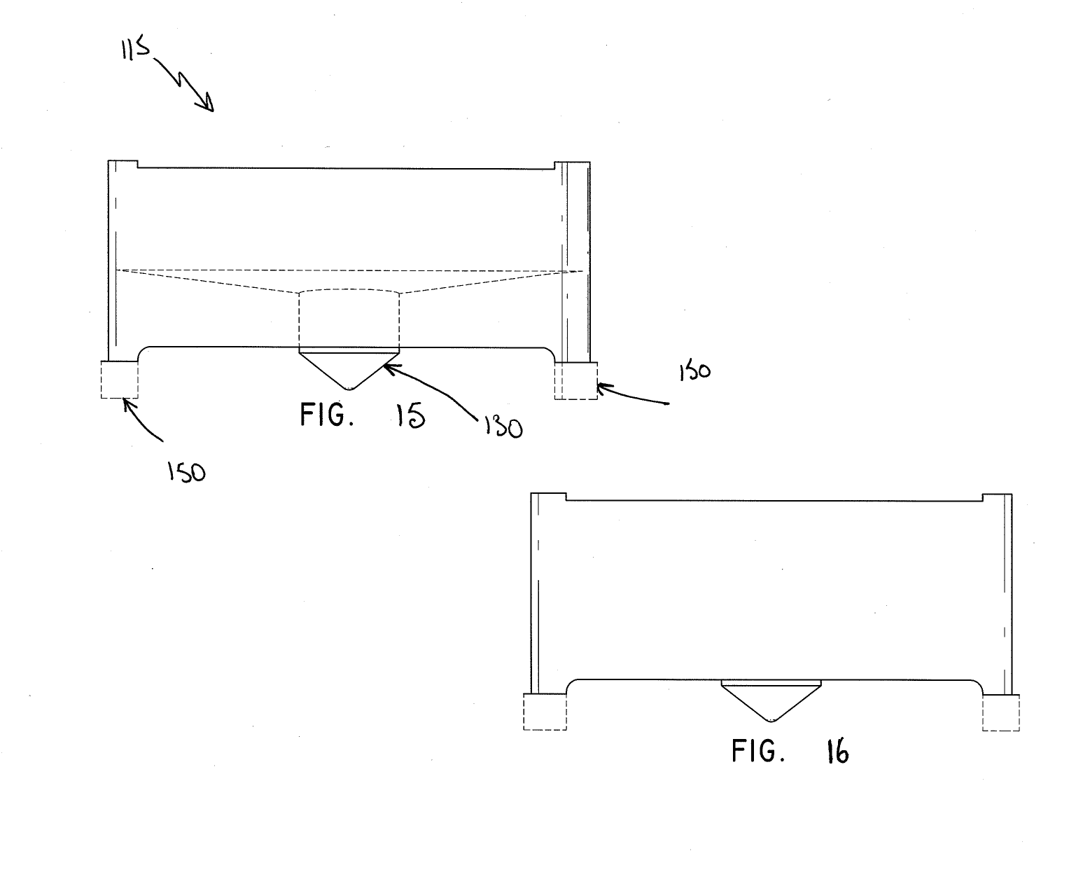

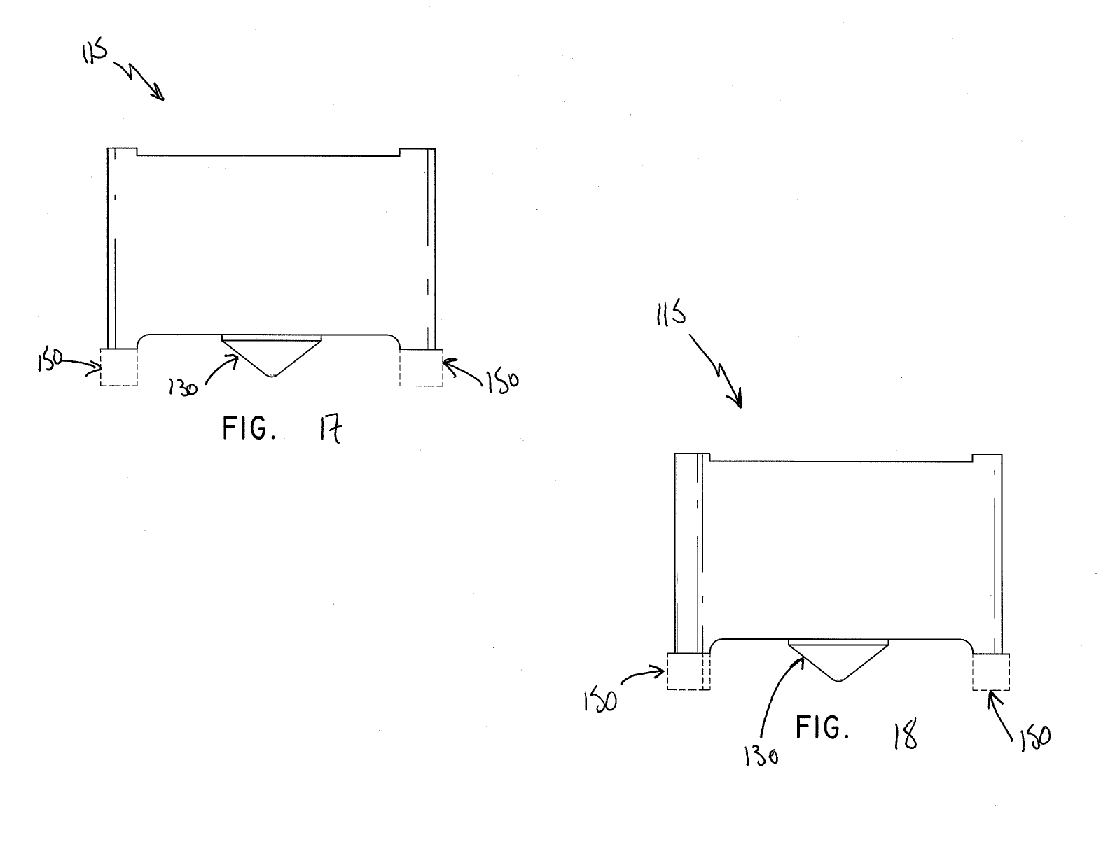

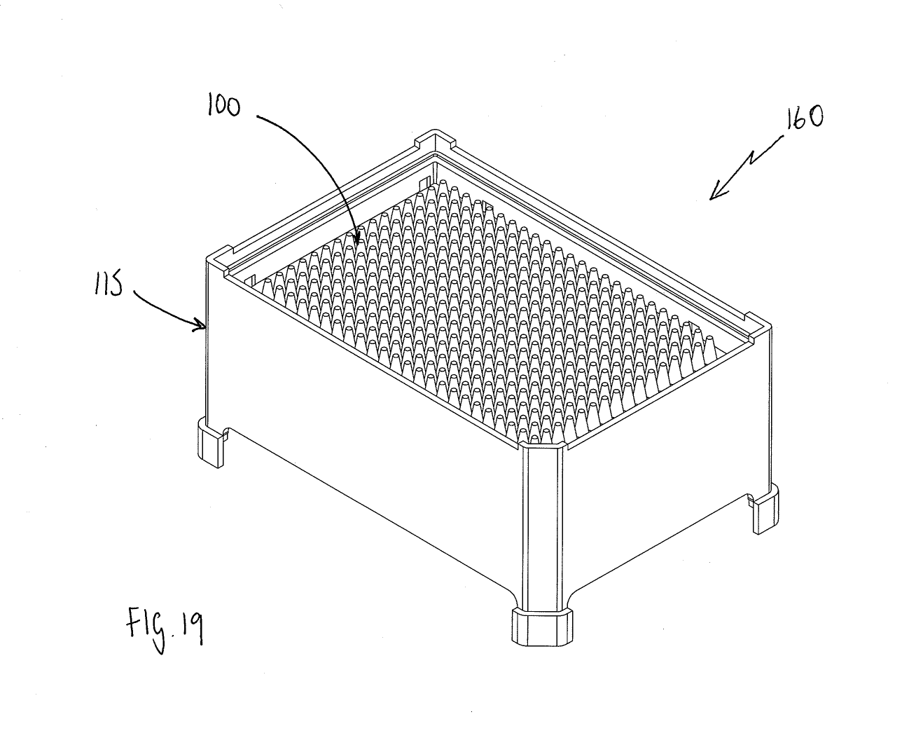

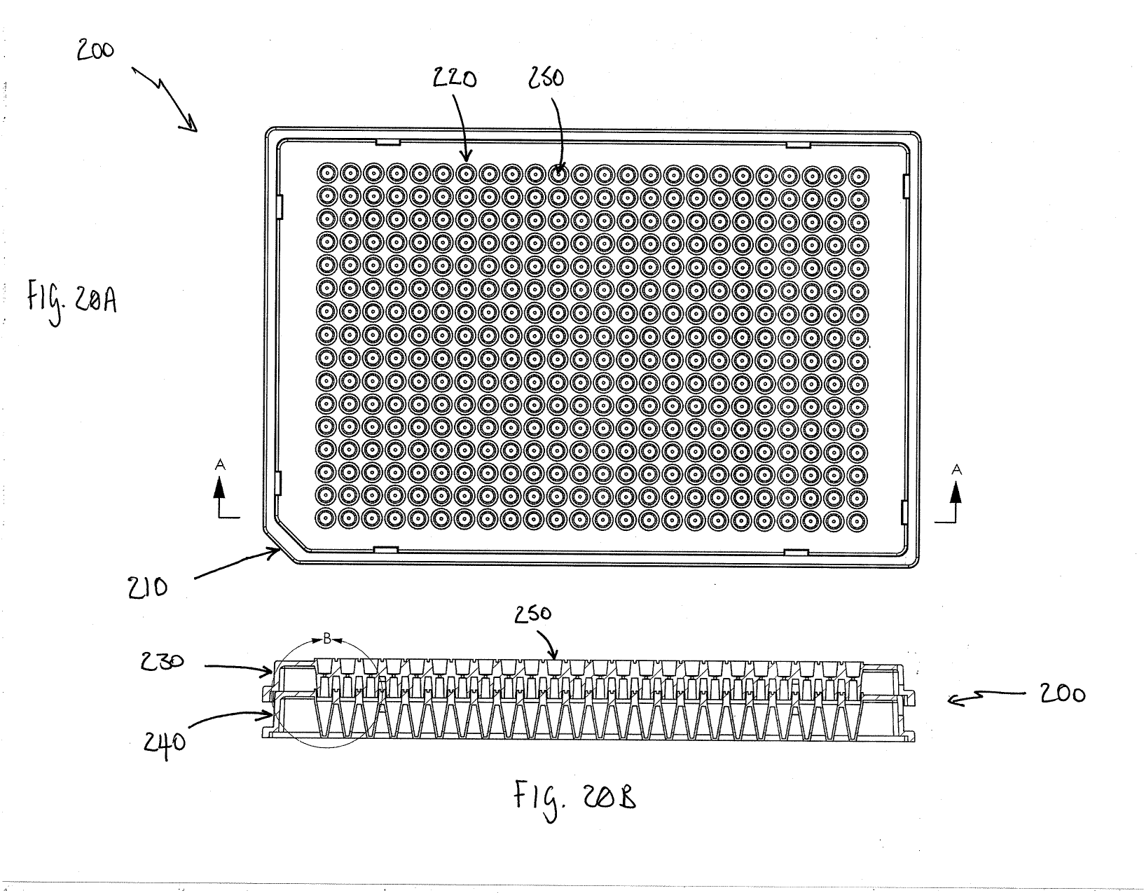

FIG. 13 shows an embodiment of a collection tray 115 which includes a bottom surface 120 which slopes to a collection cup 130. The collection tray includes an alignment element 140. The collection tray includes feet 150 configured such that collection trays may be stacked on one another. FIG. 14 shows a top-down view of the collection tray 115 of FIG. 13 which includes a bottom surface 120 that slopes down to a central collection cup 130. FIG. 15 shows a transverse section of a side view of the longer edge of the collection tray 115 of FIG. 13 which includes a central collection cup 130 in the base of the collection tray, and feet 150. FIG. 16 shows a side view of the longer edge of the collection tray 115 of FIG. 13. FIG. 17 and FIG. 18 each show a side view of the shorter edge of the collection tray 115 of FIG. 13 which includes a collection cup 130 and feet 150. FIG. 19 shows an apparatus 160 in which a multiwell plate 100 is inverted and placed in a collection tray 115.

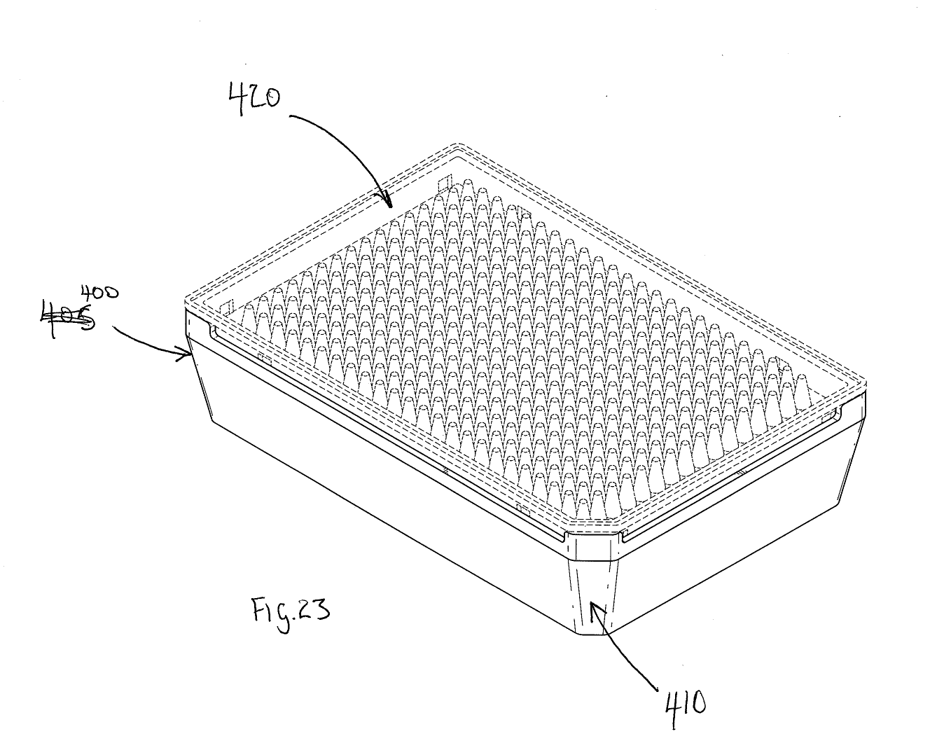

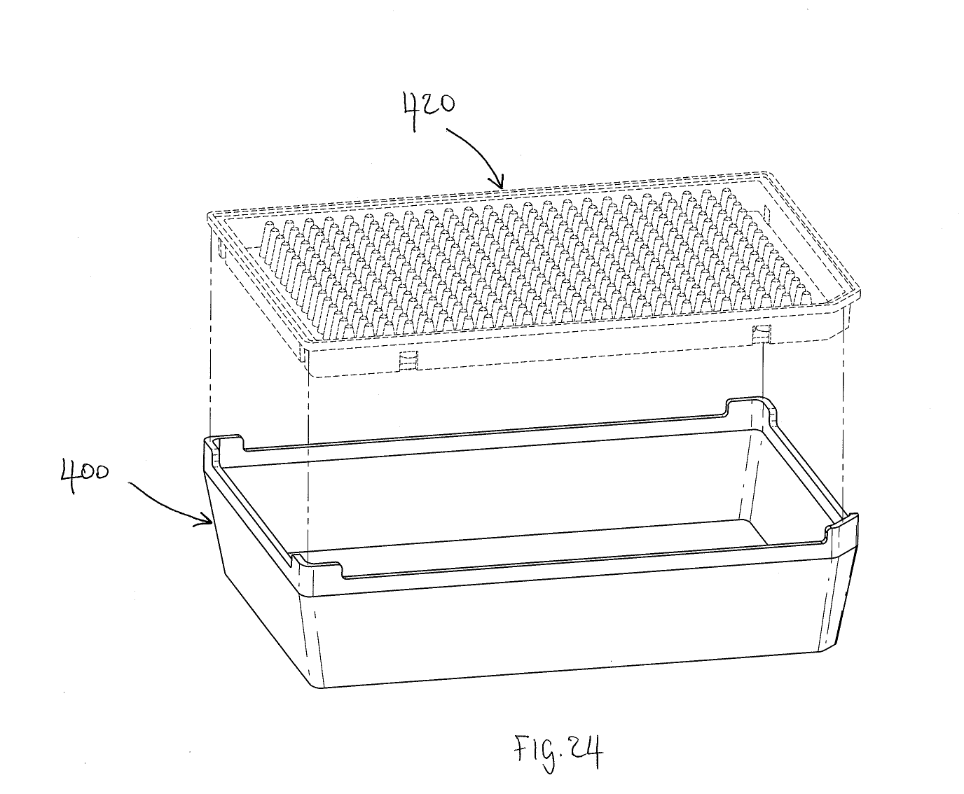

FIG. 22 shows an additional embodiment of a collection tray 400 with alignment element 410. FIG. 23 shows a collection tray 400 with alignment element 410 coupled to an inversion plate 420. FIG. 24 shows a collection plate 400 and an inversion plate 420.

Providing a Fluid to an Inversion Plate and/or a Delivery Plate

Some embodiments of the methods and compositions provided herein include a method for providing a fluid reagent to an inversion plate and/or a delivery plate. In some embodiments, wells of an inversion plate or delivery plate may be filled with one or more different fluids. In some embodiments, wells can be filled concurrently or sequentially. In some embodiments, certain wells of a plate can be filled by masking wells that are not to be filled by a fluid reagent. In some embodiments, masking different sections of the inversion plate or the delivery plate can be used to fill different wells with different reagents.

In some embodiments, one or more wells of an inversion plate or a delivery plate are filled with a fluid reagent, and the inversion plate or the delivery plate is inverted to remove excess fluid reagent.

### Providing a Fluid to a Multiwell Plate

Some embodiments of the methods and compositions provided herein include a method for providing a fluid reagent to a multiwell plate. In some embodiments, an inversion plate comprising a fluid reagent provided herein is obtained. The inversion plate is coupled with a multiwell plate. In some embodiments, the rims of the wells of the inversion plate are inserted into the wells of the multiwell plate. In some embodiments, the fluid is transferred from the inversion plate to the multiwell plate by applying a force to the inversion plate. In some embodiments, the inversion plate coupled with the multiwell plate is centrifuged thereby transferring the fluid reagent from the inversion plate to the multiwell plate. In some embodiments, the force can be a short sustained force, such as a knocking-like action on the plate for example slapping the inversion plate/multiple well plate combination on the surface of, for example, a table top to dispel the liquid from the inversion plate into the multiple well plate. In some embodiments, the force can be a series of sustained forces, such as a vibrating action on the plate. In some embodiments, coupling an inversion plate with a multiwell plate can include using an alignment collar. In some embodiments, the alignment collar, inversion plate, and multiwell plate each include an alignment element. In some embodiments, the alignment collar is coupled with the inversion plate, and coupled with the multiwell plate.

In some embodiments, a fluid is delivered to a multiwell plate with a delivery plate. In some such embodiments, a delivery plate is coupled with a multiwell plate such that the exit opening of each well of the delivery plate is aligned with each well of the multiwell plate. In some embodiments, one or more storage chambers of the delivery plate include a fluid. In some embodiments, a fluid is dispensed to one or more storage chambers of the wells of the delivery plate. The fluid can be transferred from the delivery plate to the multiwell plate by applying a force to the delivery plate such that the fluid reagent is transferred to the multiwell plate.

In some embodiments, the exit opening of some or all wells of the delivery plate comprises a rim, wherein coupling the delivery plate with the multiwell plate is such that the rim of the exit opening of each well of the delivery plate is inserted into each well of the multiwell plate.

In some embodiments, applying a force comprises centrifuging the delivery plate coupled to the multiwell plate. In some embodiments applying a force comprises tapping, shaking or agitating the plate. In some embodiments applying a force comprises applying air or other gas to the plate. In some embodiments, applying a force to the delivery plate transfers the fluid from the storage chamber to the exit chamber.

### Processing a Plurality of Reactions

Some embodiments of the methods and compositions provided herein include a method for processing a plurality of reactions. In some embodiments, the reactions are processed concurrently. Some embodiments include transferring a fluid reagent from an inversion plate or a delivery plate provided herein to a multiwell plate with a method provided herein. In some embodiments, a reaction in the multiwell plate is performed. In some embodiments, transfer of a reagent from the inversion plate or a delivery plate to the multiwell plate initiates a reaction in the multiwell plate. In some embodiments, the reaction in each well of a multiwell plate is initiated simultaneously. In some embodiments, the reaction products from a multiwell plate are removed from the multiwell plate and pooled. In some embodiments, the multiwell plate is coupled to a collection tray. A force may be applied to the multiwell plate to transfer the reaction products to the collection tray. In some embodiments, the multiwell plate coupled with the collection tray is centrifuged to transfer the reaction products to the collection tray. The pooled reaction products may be collected for further processing.

Some embodiments of the methods and compositions provided herein include a method for processing a plurality of reactions concurrently comprising coupling a delivery plate with a multiwell plate such that the rims of a plurality of the wells of the delivery plate are aligned with a plurality of the wells of the multiwell plate; applying a force to the delivery plate such that the fluid reagent is transferred from the wells of the delivery plate to the wells of the multiwell plate; and providing conditions sufficient for a plurality of reactions to occur in the plurality of the wells of the multiwell plate. In some embodiments, one or more storage chambers of the delivery plate include a fluid. In some embodiments, a fluid is dispensed to one or more storage chambers of the wells of the delivery plate. In some embodiments, coupling the delivery plate with the multiwell plate is such that the rims of a plurality of the wells of the delivery plate are inserted into the plurality of the wells of the multiwell plate. In some embodiments, providing conditions sufficient for a plurality of reactions to occur can include modulating the temperature of the wells and/or plates. In some embodiments, the fluid dispensed to the storage chambers is a fluid described herein.

In some embodiments, the multiwell plate can include samples to be processed. Examples of samples include nucleic acids, such as DNA, RNA, mRNA, mtRNA, tRNA, genomic DNA, nucleic acids from circulating tumor cells, cell free DNA . In some embodiments, the reactions can include methods of nucleic acid library synthesis, and methods of nucleic acid sequencing. In some embodiments, reactions can include method for obtaining haplotype sequence information. In some embodiments, a nucleic acid sample is distributed into a multiwell plate by limiting dilution, such that a single copy of a locus or allele is likely to be distributed into a well of the multiwell plate. The nucleic acid sample undergoes a reaction in the well of the multiwell plate, and is then pooled for further analysis

### Systems

Some embodiments of the methods and compositions provided herein include a system for processing a plurality of reactions. In some embodiments, such systems can include one or more of the following: a multiwell plate for performing a plurality of reactions; an inversion plate provided herein, in which the inversion plate provides a fluid reagent to the plurality of wells of the multiwell plate; a delivery plate provided herein, in which the delivery plate provides a fluid reagent to the plurality of wells of a multiwell plate; an alignment collar comprising an alignment element configured to align the wells of the multiwell plate with the wells of the inversion plate; and/or a collection tray configured to receive fluid reaction products from the plurality of wells of the multiwell plate multiwell plate.

### Kits

Some embodiments of the methods and compositions provided herein include an inversion plate kit. In some embodiments, the kit can include an inversion plate provided herein, in which the inversion plate includes a fluid reagent, and a lid configured to seal the wells of the inversion plate. In some embodiments, a kit can also include an alignment collar having an alignment element that aligns with the alignment element of the inversion plate. In some embodiments, a kit can also include a multiwell plate. In some embodiments, a kit can also include a collection tray.

Some embodiments of the methods and compositions provided herein include a delivery plate kit. In some embodiments, the kit can include a delivery plate provided herein, in which the delivery plate includes a fluid reagent, and a lid configured to seal the wells of the delivery plate. In some embodiments, a kit can also include an alignment collar having an alignment element that aligns with the alignment element of the delivery plate. In some embodiments, a kit can also include a multiwell plate. In some embodiments, a kit can also include a collection tray.

### EXAMPLES

### Example 1

### Tagmentation of Nucleic Acids

In this example, a fragmentation reagent is added to each well of a multiwell plate concurrently using a delivery plate. Each well of the multiwell plate comprises amplified nucleic acids. The multiwell plate is centrifuged at 500×g for 1 minute. The seal from the delivery plate is removed, and the delivery plate is placed on top of multiwell plate, lining up keyed corners and making sure that the wells of the delivery plate are centered in the wells of the multiwell plate.

A reaction master mix is prepared by adding 36 μl Tagment DNA Enzyme and 1466 μl Fragmentation Pre-Mix to a microfuge tube. The tube is inverted 10 times to mix thoroughly, then centrifuged briefly. The master mix is dispensed to the delivery plate by first transferring 180 μl of the master mix to each well of an eight-tube strip, setting a 200 μl electronic 8-channel pipette to 144 μl and 3 μl per dispense, and then adding 3 μl Tagment DNA Enzyme and Fragmentation Pre-Mix to each well of the delivery plate that is coupled to the multiwell plate. The delivery plate is sealed with a Microseal ‘B’ adhesive seal. The coupled delivery plate and multiwell plate are centrifuged at 500×g for 1 minute, making sure that the multiwell plate is on the bottom. The coupled delivery plate and multiwell plate are placed on the benchtop, with the multiwell plate on the bottom. The delivery plate is carefully removed from the multiwell plate and placed facing up, on the benchtop. All wells of the delivery plate are checked to be empty, any remaining supernatant is transferred to the corresponding well of the multiwell plate using a single channel pipette.

The contents of the wells of the multiwell plate are mixed by sealing the multiwell plate with a Microseal ‘B’ adhesive seal, and shaking the sealed plate on a microplate shaker at 1600 rpm for 30 seconds. The multiwell plate is centrifuged at 500×g for 1 minute. The sealed multiwell plate is placed on a thermal cycler and a compression mat is placed on top of the multiwell plate. A thermocycling program is selected and performed.

### Example 2

### Indexing Tagmented Nucleic Acids

In this example, a reagent is added to each well of a multiwell plate concurrently using an inversion plate. Each well of the multiwell plate comprises tagmented nucleic acids from Example 1. The inversion plate is provided with each well comprising reagent to amplify and index the tagmented nucleic acids. In this process amplifies tagmented DNA is amplified by PCR. A unique index is added to the tagmented DNA in each well of the 384-well plate and the common adapters (P5 and P7) required for cluster generation and sequencing. The inversion plate is removed from −15° C. to -25C storage and thawed at room temperature. A thermal cycler is pre-programed with the following program and saved as PostTagAmp {choose the thermal cycler pre-heat lid option and set to 100° C.; 94° C. for 1 minute; 10 cycles of: 94° C. for 15 seconds, 65° C. for 4 minutes, hold at 4° C.}. The multiwell plate is centrifuged at 500×g for 1 minute. The inversion plate is centrifuged at 500×g for 1 minute. It is verified that the droplets are at the bottom of each well of the inversion plate. The adhesive seal is removed from the multiwell plate. The foil seal is removed from the inversion plate. The inversion plate is inverted. The inversion plate is carefully placed on top of the multiwell plate, so that the corner notches and wells of both plates align. It is verified that both plates snap together tightly. The stacked inversion plate and multiwell plates are centrifuged to 500×g for 1 minute. It is verified that the multiwell plate is on the bottom. The stacked inversion plate and multiwell plates are placed on the benchtop, with the multiwell plate on the bottom. The inversion plate is carefully removed from the multiwell plate and place it, the top side facing up on the benchtop. It is verified that all wells of the inversion plate are empty. Transfer any remaining supernatant is transferred to the corresponding well of the multiwell plate using a single channel pipette. The multiwell plate is mixed thoroughly as follows: the multiwell plate is sealed with a Microseal ‘B’ adhesive seal; the multiwell plate is shaken on a microplate shaker at 1600 rpm for 30 seconds; and the multiwell plate is centrifuged at 500×g for 1 minute. The sealed multiwell plate is placed on the thermal cycler and a compression mat is placed on top of the plate. The lid is closed and the PostTagAmp program is selected and run. The multiwell plate is removed from the thermal cycler.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

1.-96. (canceled)

97. An inversion plate for providing fluid reagent to a multiwell plate, the inversion plate comprising:
a planar surface having a plurality of sites distributed thereon, wherein each site comprises a well having a rim raised above the planar surface, wherein each well is configured such that a fluid is retained in the well when the planar surface is inverted; and
an alignment element configured to align with an alignment element of an alignment collar or an alignment element on a multiwell plate.

98. The inversion plate of claim 97, wherein the rim is configured to be inserted into a well of a multiwell plate, and the locations of the wells on the planar surface align with the locations of a plurality of wells of a multiwell plate.

99. The inversion plate of claim 97, wherein the inversion plate is adapted for robotic manipulation.

100. The inversion plate of claim 97, wherein the fluid comprises a volume less than about 5 μl.

101. The inversion plate of claim 1, wherein the fluid comprises a reagent for nucleic acid synthesis.

102. The inversion plate of claim 97, wherein at least two wells comprise different fluids.

103. The inversion plate of claim 97, wherein the well has a depth between about 8 mm and 12 mm.

104. An inversion plate kit comprising:
the inversion plate of claim 97, wherein a plurality of the wells comprise a fluid reagent; and
a lid configured to seal the wells of the inversion plate.

105. The inversion plate kit of claim 104, comprising one or more selected from the group consisting of an alignment collar having an alignment element that aligns with the alignment element of the inversion plate, a multiwell plate, and a collection tray configured to receive the multiwell plate.

106. A method for providing a fluid reagent to a multiwell plate comprising:
providing the inversion plate of claim 97, wherein each well comprises the fluid reagent;
coupling the inversion plate with a multiwell plate such that the rim of each well of the inversion plate is aligned with each well of the multiwell plate; and
applying a force to the inversion plate such that the fluid reagent is transferred to the multiwell plate.

107. The method of claim 106, wherein coupling the inversion plate with the multiwell plate is such that the rim of each well of the inversion plate is inserted into each well of the multiwell plate.

108. The method of claim 106, wherein the coupling comprises contacting the inversion plate and multiwell plate with an alignment collar having an alignment element; and
aligning the alignment element of the inversion plate with an alignment element of the alignment collar.

109. The method of claim 106, wherein the applying a force is selected from the group consisting of centrifuging the inversion plate coupled to the multiwell plate, and vibrating the inversion plate coupled to the multiwell plate.

110. A method for processing a plurality of reactions concurrently comprising:
providing the inversion plate of claim 97, wherein each well comprises a fluid reagent;
coupling the inversion plate with a multiwell plate such that the rims of a plurality of the wells of the inversion plate are aligned with a plurality of the wells of the multiwell plate;
applying a force to the inversion plate such that the fluid reagent is transferred from the wells of the inversion plate to the wells of the multiwell plate;
allowing a plurality of reactions to occur in the plurality of the wells of the multiwell plate, thereby obtaining reactants; and
removing the reactants from the multiwell plate to a collection tray.

111. The method of claim 110, wherein coupling the inversion plate with the multiwell plate is such that the rims of a plurality of the wells of the inversion plate are inserted into the plurality of the wells of the multiwell plate.

112. The method of claim 110, wherein removing the reactants comprises:
coupling the multiwell plate to a collection tray; and
applying a force to the multiwell plate coupled to the collection tray such that the reactants are transferred from the wells of the multiwell plate to the wells of the multiwell plate.

113. The method of claim 112, wherein coupling the inversion plate with a multiwell plate comprises contacting the inversion plate and multiwell plate with an alignment collar; and aligning the alignment element of the inversion plate with an alignment element of the alignment collar.

114. The method of claim 112, wherein applying a force to the inversion plate is selected from the group consisting of centrifuging the inversion plate coupled to the multiwell plate, and vibrating the inversion plate coupled to the multiwell plate.

115. A delivery plate for providing fluid reagent to a multiwell plate, the delivery plate comprising a plurality of wells, each well having a storage opening and an exit opening with a sidewall extending therebetween, wherein the sidewall comprises a constriction forming a storage chamber between the storage opening and the constriction and an exit chamber between the exit opening and the constriction, the constriction configured such that a fluid can be retained in the storage chamber and can be moved through the constriction to the exit chamber on application of a force.

116. The delivery plate of claim 115, wherein at least one opening of a well comprises a rim raised above a surface of the plate, wherein the rim is configured to be inserted into the well of a multiwell plate, wherein the locations of the wells align with the locations of a plurality of wells of a multiwell plate.

117. The delivery plate of claim 115, further comprising an alignment element configured to align with an alignment element on a multiwell plate.

118. The delivery plate of claim 115, wherein the constriction comprises an open aperture having a radius of at least about 10 μm.

119. The delivery plate of claim 115, wherein the storage chamber has a depth from the storage opening to the constriction of at least about 100 μm.

120. The delivery plate of claim 115, wherein the exit chamber has a depth from the exit opening to the constriction of at least about 100 μm.

121. The delivery plate of claim 115, adapted for robotic manipulation.

122. The delivery plate of claim 115, wherein the fluid comprises a volume less than about 5 μl.

123. The delivery plate of claim 115, wherein the fluid comprises a reagent for nucleic acid synthesis.

124. The delivery plate of claim 115, wherein at least two wells comprise different fluids.

125. A delivery plate kit comprising:
the delivery plate of claim 115, wherein a plurality of the wells comprise a fluid reagent; and
a lid configured to seal the wells of the delivery plate.

126. The delivery plate kit of claim 125, further comprising one or more selected from the group consisting of the inversion plate of claim 1, an alignment collar having an alignment element that aligns with the alignment element of the delivery plate, a multiwell plate, and a collection tray.

127. The delivery plate kit of claim 125, wherein the storage chamber of each well comprises a fluid.

128. A method for providing a fluid reagent to a multiwell plate comprising:
providing the delivery plate of claim 115, wherein at least one well comprises the fluid reagent;
coupling the delivery plate with a multiwell plate such that the exit opening of each well of the delivery plate is aligned with each well of the multiwell plate; and
applying a force to the delivery plate such that the fluid reagent is transferred to the multiwell plate.

129. The method of claim 128, wherein the exit opening of each well of the delivery plate comprises a rim, wherein coupling the delivery plate with the multiwell plate is such that the rim of the exit opening of each well of the delivery plate is inserted into each well of the multiwell plate.

130. The method of claim 128, wherein the applying a force comprises centrifuging the delivery plate coupled to the multiwell plate such that the fluid is transferred from the storage chamber to the exit chamber.

131. A method for processing a plurality of reactions concurrently comprising:
providing the delivery plate of any one of claims 115, wherein each well comprises a fluid reagent, and each exit opening comprises a rim;
coupling the delivery plate with a multiwell plate such that the rims of a plurality of the wells of the delivery plate are aligned with a plurality of the wells of the multiwell plate;
applying a force to the delivery plate such that the fluid reagent is transferred from the wells of the delivery plate to the wells of the multiwell plate; and
providing conditions sufficient for a plurality of reactions to occur in the plurality of the wells of the multiwell plate, thereby obtaining reactants.

132. The method of claim 131, wherein coupling the delivery plate with the multiwell plate is such that the rims of a plurality of the wells of the delivery plate are inserted into the plurality of the wells of the multiwell plate.

133. The method of claim 131, wherein applying a force to the delivery plate is selected from the group consisting of centrifuging the delivery plate coupled to the multiwell plate, and vibrating the delivery plate coupled to the delivery plate.
